(19) United States
(12) Patent Application Publication
(10) Pub. No.: US 2026/0225347 A1
(43) Pub. Date: Aug. 6, 2026

(54) NICKEL-PLATED METAL SHEET

(71) Applicant: TOYO KOHAN CO., LTD., Tokyo (JP)

(72) Inventors: Yusuke HASHIMOTO, Yamaguchi (JP); Takahiro WATANABE, Yamaguchi (JP); Etsuro TSUTSUMI, Yamaguchi (JP); Shinichirou HORIE, Yamaguchi (JP); Daisuke MATSUSHIGE, Yamaguchi (JP); Yasunori IDE, Yamaguchi (JP); Yuhei HAMAOKA, Yamaguchi (JP)

(73) Assignee: TOYO KOHAN CO., LTD., Tokyo (JP)

(21) Appl. No.: 19/147,838

(22) PCT Filed: Jan. 16, 2024
(86) PCT No.: PCT/JP2024/001036

§ 371 Date: Jul. 14, 2025

(30) Foreign Application Priority Data
Jan. 16, 2023 (JP) 2023-004753
Jan. 16, 2023 (JP) 2023-004754
Apr. 28, 2023 (JP) 2023-075275
Oct. 27, 2023 (JP) 2023-185107
Oct. 27, 2023 (JP) 2023-185109
Oct. 27, 2023 (JP) 2023-185109

(51) Int. Cl. B32B 15/01; C25D 3/12; C25D 3/22

(52) U.S. Cl. CPC B32B 15/015; C25D 3/12; C25D 3/22; B32B 2250/02; B32B 2250/03; B32B 2307/718; B32B 2307/7376; B32B 2311/20; B32B 2311/22; B32B 2311/30

(57) ABSTRACT

[Object]

Disclosed is a nickel-plated metal sheet, which includes a plating layer having adhesion with a base material and adhesion with another member, and further is capable of shortening a joining time or lowering a joining temperature compared to the conventional technology, when joined with another member.

[Solving Means]

The nickel-plated metal sheet includes a base material made of metal, and a roughened nickel layer formed on at least one side on the base material. A ten-point mean roughness Rzjis on an outermost surface on a side of the roughened nickel layer is 1.0 to 4.5 μm, and a Density Of Peaks Spd on the outermost surface on the side of the roughened nickel layer is 20000/mm² or higher.

### TECHNICAL FIELD

The present disclosure relates to a nickel-plated metal sheet.

### BACKGROUND ART

In recent years, in a technology that forms a plating layer on a base material such as a metal sheet or a metal foil, techniques are not limited to smoothly forming the plating layer, and are known to form roughness on a plating surface or to deposit metal in a granular or acicular form on the base material, that is, to form what is called a roughened plating layer.

For example, PTL 1 discloses a roughened nickel-plated sheet, the lightness and 85° gloss of a surface of a roughened nickel layer of which are specified to provide the roughened nickel-plated sheet with excellent adhesion with another member while allowing the plating layer to hold adhesion with a base material. Further, PTL 2 discloses a roughened nickel-plated sheet improved in liquid penetration resistance when joined with another member, in addition to the adhesion of a plating layer to a base material and adhesion with another member.

### CITATION LIST

### Patent Literature

### [PTL 1]

PCT Patent Publication No. WO2020/017655

### [PTL 2]

PCT Patent Publication No. WO2021/149821

### SUMMARY

### Technical Problem

When an appliance is manufactured with a roughened nickel-plated material, another member may be joined to a side of a roughened nickel-plating layer. The joining of both of them is conducted, for example, by causing resin, which has been melted or softened through heating, to flow in under pressure between protrusions on the side of the roughened nickel layer and then cooling it. There is an outstanding demand to shorten the joining time or to lower the joining temperature in the joining step for reduction of environmental load and improvement of productivity. In the case of a base material including a conventional roughened nickel layer, however, there were cases in which resin was less likely to flow to roots of roughness-forming protrusions. Especially if there is a need to increase adhesion (hereinafter also called “adhesion strength”) with another member, the protrusions of roughened nickel need to be formed tall. As a result, there is a need to lengthen the joining time or to raise the joining temperature such that the resin is allowed to fill to the roots of the roughness-forming protrusions. There has hence been a demand for improvement from the viewpoint of reduction of environmental load and improvement of productivity.

The present disclosure has been made with a view to solving such a problem, and has as an object thereof the provision of a nickel-plated metal sheet, which includes a plating layer having adhesion with a base material and adhesion with another member, and further is capable of shortening a joining time or lowering a joining temperature compared to the conventional technology, when joined with another member.

### Solution to Problem

To solve the above-described problem, a nickel-plated metal sheet of the present embodiment is (1) a nickel-plated metal sheet including a base material made of metal and a roughened nickel layer formed on at least one side on the base material. A ten-point mean roughness Rzjis on an outermost surface on a side of the roughened nickel layer of the nickel-plated metal sheet is 1.0 to 4.5 μm, and a Density Of Peaks Spd on the outermost surface on the side of the roughened nickel layer is 20000/mm² or higher.

In (1) described above, (2) the ten-point mean roughness Rzjis is preferably 1.0 to 3.9 μm.

In (2) described above, (3) if an arithmetical mean curvature Spc of peaks is 200/mm or greater and smaller than 390/mm, a relation of Spd≥33.3 Spc+15000 is preferably satisfied, or if Spc is 390/mm or greater, Spd≥28000 is preferably satisfied.

In (1) or (3) described above, (4) nickel preferably exists in the outermost surface on the side of the roughened nickel layer.

In (1) or (3) described above, (5) a zinc layer is preferably further included on the outermost surface on the side of the roughened nickel layer.

In (1) or (3) described above, (6) a deposition amount of nickel in the roughened nickel layer is preferably 2.0 g/m² or more and 16 g/m² or less.

In (1) or (3) described above, (7) a thickness of the base material is preferably 0.01 to 1.0 mm.

In (1) or (3) described above, (8) the base material is preferably any one of a metal sheet or metal foil made of one type of pure metal selected from iron, copper, aluminum, and nickel, a metal sheet or metal foil made of an alloy containing one type selected from iron, copper, aluminum, or nickel, a nickel-plated steel sheet or a metal sheet applied on a surface thereof with an alloy phase of iron and nickel by subjecting a nickel-plated steel sheet to heat treatment, or a zinc-plated steel sheet.

In (1) or (3) described above, (9) a metal layer is preferably included between the base material and the roughened nickel layer, and the metal layer is preferably any one of an iron-nickel alloy layer, a nickel-phosphorus alloy layer, or a nickel layer.

In (1) or (3) described above, (10) a total nickel deposition amount per side in the metal layer and the roughened nickel layer, the side being on the side of the roughened nickel layer, of the nickel-plated metal sheet is preferably 4 g/m² or more and 40 g/m² or less.

### Advantageous Effect of Invention

According to the present disclosure, it is possible to provide a nickel-plated metal sheet, which includes a plating layer having adhesion with a base material and adhesion with another member, and further is capable of shortening the joining time or lowering the joining temperature compared to the conventional technology, when joined with another member.

### BRIEF DESCRIPTION OF DRAWINGS

FIG. 1 is a cross-sectional view schematically depicting a nickel-plated metal sheet of the present embodiment.

FIG. 2 is a cross-sectional view schematically depicting a nickel-plated metal sheet according to another embodiment.

FIG. 3 is a cross-sectional view schematically depicting a nickel-plated metal sheet according to still another embodiment.

FIG. 4 is a cross-sectional view schematically depicting a nickel-plated metal sheet according to yet another embodiment.

FIG. 5 is a graph presenting a method example for determining the thickness of an iron-nickel diffusion alloy layer.

### DESCRIPTION OF EMBODIMENTS

### <<Nickel-Plated Metal Sheet>>

A description will hereinafter be made regarding embodiments for implementing the nickel-plated metal sheet of the present disclosure. It is to be noted that the term “roughened portion” as used herein shall represent an area including a roughened nickel layer formed on a base material and having a ten-point mean roughness Rzjis of 1.0 μm or greater on a side of the roughened nickel layer formed on one side on the base material 20.

### First Embodiment

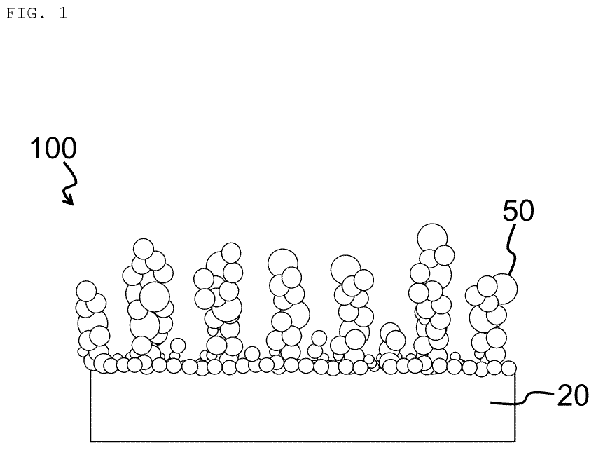

FIG. 1 is a cross-sectional view schematically depicting an embodiment of a nickel-plated metal sheet 100 of the present disclosure. It is to be noted that the nickel-plated metal sheet 100 of the present embodiment is used, for example, as current collectors of positive electrodes and/or negative electrodes of secondary batteries and the like, members for electronic devices, electric appliances, automobiles, and constructions, and so on.

The nickel-plated metal sheet 100 of the present embodiment includes the base material 20 made of metal, and a roughened nickel layer 50 formed on the base material 20.

### <Base Material 20>

As the base material 20 for use in the nickel-plated metal sheet 100 of the present embodiment, a metal sheet or metal foil made of a pure metal selected from iron (Fe), copper (Cu), aluminum (Al), and nickel (Ni), or a metal sheet or metal foil made of an alloy containing one type selected from iron (Fe), copper (Cu), aluminum (Al), and nickel (Ni) can be used, for example. It is also possible to use a nickel-plated steel sheet, a metal sheet (hereinafter also called the “surface diffusion-treated steel sheet”) with an iron-nickel diffusion alloy layer formed on a surface layer or in a vicinity of the surface layer by subjecting a nickel-plated steel sheet to heat treatment, a zinc-plated steel sheet, or the like.

In the viewpoint of improving the plating adhesion between the base material 20 and the roughened nickel layer 50 and a composite roughened plating layer 60 to be described in a latter part, a steel sheet, iron foil, or a surface diffusion-treated steel sheet is preferred as the base material 20. In the viewpoint of improving the corrosion resistance of the whole metal sheet, on the other hand, a nickel-plated steel sheet, a surface diffusion-treated steel sheet, or a zinc-plated steel sheet is preferred as the base material 20. In the viewpoint of satisfying these plating adhesion and corrosion resistance together, a surface diffusion-treated steel sheet is particularly preferred.

If the base material 20 is a steel sheet, chromium (Cr) and other additive metal elements are preferably lower than 1.0 wt %. Specifically, low-carbon steel (carbon content: 0.01 to 0.15 wt %) represented by low-carbon aluminum-killed steel, ultralow-carbon steel having a carbon content of lower than 0.01 wt %, or non-aging ultralow-carbon steel prepared by adding titanium (Ti), niobium (Nb), and/or the like to ultralow-carbon steel is suitably used.

It is to be noted that, if a nickel-plated steel sheet, a surface diffusion-treated steel sheet, or a zinc-plated steel sheet is used as the base material 20, low-carbon steel (carbon content: 0.01 to 0.15 wt %) represented by low-carbon aluminum-killed steel, ultralow-carbon steel having a carbon content of lower than 0.01 wt %, or non-aging ultralow-carbon steel prepared by adding Ti, Nb, and/or the like to ultralow-carbon steel, which are/is similar to those/that described above, is suitably used as the base material.

If the base material 20 is an iron foil, a pure iron foil is preferred from the viewpoints of elongation, corrosion resistance, and the above-described plating adhesion, and from the viewpoint of thinning in particular, the whole base material 20 is preferably an electrolytic iron foil that is obtained by electrolytic plating.

It is to be noted that, if a metal base material with a passive film formed on a surface thereof, such as a stainless steel sheet, a nickel sheet, a nickel-plated steel sheet, or a surface diffusion-treated steel sheet, is used as the base material 20, strike nickel plating is preferably applied before plating treatment that forms the roughened nickel layer 50 or a metal layer 40 to be described in a latter part. Conditions for the strike nickel plating are not particularly limited, but may include, for example, the following conditions or the like. Under the below-described conditions, the deposition amount of nickel by strike nickel plating is generally 0.01 to 0.89 g/m². If a nickel layer (also called an “undercoat nickel layer”) is formed as the metal layer 40, the total amount of a deposition amount of nickel by strike nickel plating and a nickel deposition amount by nickel plating to form the undercoat nickel layer is measured as the nickel deposition amount of the undercoat nickel layer.

### Examples of Strike Nickel-Plating Conditions

Bath composition:
Nickel sulfate hexahydrate 100 to 300 g/L, sulfuric acid: 10 to 200 g/L
pH: 1.0 or lower
Bath temperature: 40° C. to 70° C.
Current density: 5 to 100 A/dm²
Plating time: 3 to 100 seconds

If the base material 20 is a pure aluminum sheet, a pure aluminum foil, an aluminum alloy sheet, or an aluminum alloy foil, on the other hand, zincate treatment that conducts substitution plating of zinc on a surface of aluminum is preferably applied before plating treatment that forms the roughened nickel layer 50 or the metal layer 40 to be described in the latter part. Zincate treatment conditions are not particularly limited, but may include, for example, the following conditions or the like. To the pure aluminum sheet or the pure aluminum foil, or the aluminum alloy sheet or the aluminum alloy foil, degreasing is conducted with an alkaline solution, etching treatment is next applied in sulfuric acid, and desmut treatment is then applied in a solution with nitric acid and a ferric chloride solution mixed therein. After that, the resulting pure aluminum sheet or pure aluminum foil, or the resulting aluminum alloy sheet or aluminum alloy foil is dipped in the below-described zincate treatment solution to conduct first zincate treatment. Subsequently, the resulting pure aluminum sheet or pure aluminum foil, or aluminum alloy sheet or aluminum alloy foil is dipped in the same treatment solution as that used in the desmut treatment, thereby removing zinc substitution-precipitated by the first zincate treatment, and is then dipped in the same treatment solution as that used in the first zincate treatment, to conduct a second zincate treatment (hereinafter also called “double zincate treatment”). In this case, water rinsing treatment is conducted after the treatment in each step. It is to be noted that the deposition amount of zinc can be adjusted by appropriately choosing the concentration of zinc ions in the treatment solution and the time during which the dipping in the treatment solution is conducted in the second zincate treatment. As an alternative, the substitution plating of zinc may also be conducted by conducting only the step of the first zincate treatment after the degreasing treatment, pickling treatment, and desmut treatment, that is, by applying single zincate treatment. Here, the deposition amount of zinc can be adjusted by appropriately choosing the concentration of zinc ions in the treatment solution and the time during which the dipping in the treatment solution is conducted in the first zincate treatment. It is to be noted that the deposition amount of zinc formed by the double zincate treatment or single zincate treatment is desirably formed to fall preferably in a range of 5 to 600 mg/m², more preferably in a range of 30 to 400 mg/m², to improve the adhesion of the metal layer 40 to be formed subsequently. By this double zincate treatment or single zincate treatment, a zinc layer may be formed between the roughened nickel layer or metal layer 40 and the base material 20. It is to be noted that the deposition amount of the zinc layer formed by the double zincate treatment or single zincate treatment can be measured by X-ray fluorescence (XRF) analysis or the like.

### Examples of Zincate Treatment Conditions

### <<Degreasing Conditions>>

Bath composition:
Sodium hydroxide 10 to 50 g/L, sodium carbonate 2 to 20 g/L
pH: 12 or higher
Bath temperature: 5° C. to 80° C.
Dipping time: 10 seconds to 3 minutes

### <<Pickling Conditions>>

Bath composition:
Sulfuric acid 40 to 100 g/L
pH: 1.0 or lower
Bath temperature: 5° C. to 80° C.
Dipping time: 10 seconds to 3 minutes

### <<Desmut Conditions>>

Bath composition:
60% nitric acid 100 to 400 mL/L, ferric chloride solution 1 to 10 mL/L
pH: 1.0 or lower
Bath temperature: 5° C. to 80° C.
Dipping time: 10 seconds to 2 minutes

### <<First Zincate Conditions>>

Bath composition:
Sodium hydroxide 100 to 200 g/L, Rochelle salt 20 to 80 g/L, zinc oxide 10 to 50 g/L, ferrous chloride 0.5 to 3.0 g/L
pH: 12 to 14
Bath temperature: 5° C. to 50° C.
Dipping time: 10 seconds to 2 minutes

### <<Dezincate Conditions>>

Bath composition:
60% nitric acid 100 to 400 mL/L, ferric chloride solution 1 to 10 mL/L
pH: 1.0 or lower
Bath temperature: 5° C. to 50° C.
Dipping time: 10 seconds to 2 minutes

### <<Second Zincate Conditions>>

Bath composition:
Sodium hydroxide 100 to 200 g/L, Rochelle salt 20 to 80 g/L, zinc oxide 10 to 50 g/L, ferrous chloride 0.5 to 3.0 g/L
pH: 12 to 14
Bath temperature: 5° C. to 50° C.
Dipping time: 10 seconds to 2 minutes

As the thickness of the base material 20 for use in the nickel-plated metal sheet 100 of the present embodiment, a range of 0.01 to 1.0 mm is suited. If used as a current collector in a battery, for example, improvement in volumetric and gravimetric energy densities is required. Taking into consideration balancing of lightweighting and thinning with strength, the thickness of the base material 20 is hence preferably 0.01 to 0.5 mm, more preferably 0.01 to 0.3 mm, and still more preferably 0.025 to 0.1 mm. Further, in applications, for example, such as members for electronic devices, electric appliances, automobiles, and constructions, and so on, the thickness of the base material 20 is preferably 0.025 to 1.0 mm, more preferably 0.1 to 1.0 mm, still more preferably 0.2 to 1.0 mm, and even still more preferably 0.5 to 1.0 mm from the viewpoints of rigidity, strength, and workability.

For the thickness of the base material 20, thickness measurement by cross-sectional observation under an optical microscope or a scanning electron microscope (SEM) is suitably applied. For thickness measurement before the surface treatment, specifically before the nickel plating or iron-nickel alloy plating, thickness measurement by a micrometer, or the like can be applied.

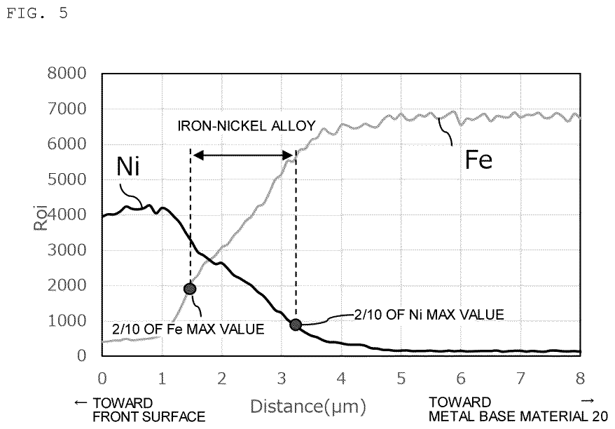

As a method for determining the thickness of a diffusion alloy layer of iron and nickel when a surface diffusion-treated steel sheet is used as the base material 20, a method that reads it from a graph (see FIG. 5) obtained by scanning electron microscope-energy dispersive X-ray spectrometry (SEM-EDX) as in PCT Patent Publication No. WO2022/231009 can be applied.

Specifically, in FIG. 5, the abscissas represent distances (μm) in a depth direction from a side of a surface layer, and the ordinates represent X-ray strengths of Ni and Fe. In the graph of FIG. 5, it is indicated that a portion, which is shallow toward a thickness direction, is high in nickel content and low in iron content. As the distance increases in the thickness direction, on the other hand, the content of iron progressively increases. Assuming that, in a portion before and after the curve of nickel and the curve of iron cross, the distance between 2/10 of the maximum value of nickel and 2/10 of the maximum value of iron corresponds to the diffusion alloy layer of iron and nickel in the present embodiment, its thickness can be read from the graph.

As the thickness of the diffusion alloy layer of iron and nickel in the surface diffusion-treated steel sheet, its thickness on at least one side is preferably 0.4 μm or greater, more preferably 0.6 μm or greater, and still more preferably 0.7 μm or greater from the viewpoint of improvement in corrosion resistance. Although there is no upper limit in particular, the thickness per side of the diffusion alloy layer of iron and nickel is preferably 7.5 μm or smaller, more preferably 6.0 μm or smaller, from the viewpoints of productivity and manufacturing cost. In the surface diffusion-treated steel sheet, it is preferred that, on its both sides, a diffusion alloy layer of iron and nickel be formed with a thickness of 0.4 μm or greater and 7.5 μm or smaller.

Further, the roughness of the base material 20 is not particularly limited, but the arithmetical mean roughness Ra by a contact probe surface roughness meter is 0.05 to 0.9 μm, more preferably 0.05 to 0.5 μm, still more preferably 0.05 to 0.3 μm, and particularly preferably 0.08 to 0.2 μm. It is to be noted that the arithmetical mean roughness Ra conforms to Japanese Industrial Standard (JIS) B 0601:2013.

### <Roughened Nickel Layer 50>

The roughened nickel layer 50 may be formed on an outermost surface on one side of the nickel-plated metal sheet 100 as depicted in FIG. 1, or may be formed on outermost surfaces on both sides although not depicted in any of the figures. The roughened nickel layer 50 is formed with nickel or a nickel-based alloy.

The nickel-plated metal sheet of the present embodiment is characterized in that, on the surface on the side of the roughened nickel layer 50, its ten-point mean roughness Rzjis is 1.0 to 4.5 μm and its Density Of Peaks Spd is 20000/mm² or higher. Owing to the specification of the surface shape of the roughened nickel layer 50 as described above, the nickel-plated metal sheet of the present embodiment, for example, when joined with another member such as resin, facilitates flowing-in of the resin upon heating and pressing, and a sufficient joint strength is obtained after cooling. Moreover, it is also possible to shorten the joining time or to lower the joining temperature compared to the conventional technology.

It is to be noted that the term “resin” as used herein includes a thermoplastic resin, a thermosetting resin, a rubber, an elastomer, or the like. In the present disclosure, the resin also includes a material having fluidity when joined with the roughened nickel layer, such as one partly containing resin in a slurry material, such as a coating material or an active material.

Specifically, the ten-point mean roughness Rzjis is a value corresponding to the heights of protrusions on the roughened portion in the nickel-plated metal sheet of the present embodiment. In the present disclosure, the ten-point mean roughness Rzjis is specified in the above-described range as characteristics of the shape of the roughened portion, which facilitates flowing-in of the resin to roots of the roughened portion and makes it possible to obtain preferred adhesion between the flowed-in resin and the roughened portion. By also specifying the below-described range of Density Of Peaks Spd, preferred effects can be exhibited.

Further, the Density Of Peaks Spd is a value corresponding to the number of protrusions per unit area of the roughened portion. In the present disclosure, preferred effects can be exhibited by specifying the Density Of Peaks Spd in the above-described range as characteristics of the shape of the roughened portion, with which preferred adhesion is obtained between the flowed-in resin and the roughened portion, from the viewpoint of balancing with the above-described range of the ten-point mean roughness Rzjis.

Regarding reasons that the preferred effects are obtained by controlling the ten-point mean roughness Rzjis and Density Of Peaks Spd, the present inventors consider as follows. If the ten-point mean roughness Rzjis exceeds 4.5 μm as in conventional roughened nickel-plated materials, the adhesion with resin tends to be high. However, the heights of the protrusions on the roughened portion are tall, so that, when the roughened portion is joined with the resin, joining treatment for a long time or at a high temperature is needed to allow the resin to flow to near the roots on the roughened portion. After examining the resin adhesion on roughened nickel layers the ten-point mean roughness Rzjis values of which were 1.0 to 4.5 μm, on the other hand, it was found that the resin adhesion decreased in some instances. The present inventors repeated trials and errors with a view to determining a shape of a roughened portion, which makes it possible to shorten the joining time and/or to lower the joining temperature while holding high resin adhesion. As a result, interested in the number of protrusions on the roughened portion that contributes to the resin adhesion, it was found that, by controlling the Density Of Peaks Spd to 20000/mm² or higher, the points of contact between the resin and the roughened portion can be increased, and as a result, anchoring effect is improved, thereby further improving the adhesion between the resin and the roughened portion. In other words, with respect to the conventional roughened nickel layers, no consideration was made regarding Spd that represents the number of protrusions at the roughened portion, the protrusion number was somewhat small, and when the Rzjis was controlled to 4.5 μm or smaller, the resin adhesin decreased. It is to be noted that, if the Rzjis is smaller than 1.0 μm, flowing-in of the resin is further facilitated, but due to an insufficient height of the roughened portion, the adhesion with the resin is significantly reduced. In the present disclosure, the ten-point mean roughness Rzjis and Density Of Peaks Spd are controlled such that they fall in the prescribed ranges, whereby the ease of flowing-in of the resin (hereinafter also called the “resin flowability”) is improved, thereby making it possible to obtain high adhesion between the resin and the roughened portion in a shorter joining time or at a lower joining temperature.

The nickel-plated metal sheet of the present embodiment facilitates flowing of the resin or the like to the roots on the roughened portion of the roughened nickel layer, and can shorten the joining time required to obtain a high strength. An evaluation of resin flowability can be conducted on the basis of a time required to obtain an adhesion strength of 90% or higher relative to the adhesion strength (maximum adhesion strength) available when a sufficient joining time is taken at a prescribed temperature around the melting point of the resin. If the adhesion strength is 90% or higher, it is possible to evaluate that another member (resin) is filled between the shapes of the protrusions on the roughened portion and sufficient characteristics are exhibited. Further, it is possible to evaluate that the shorter the time required to reach the adhesion strength of 90% or higher, the easier the resin flows. It is to be noted that, if another member is resin, the 90% adhesion strength is preferably 9N/25 mm or higher for high adhesion.

It is to be noted that, from the viewpoint of increasing the resin flowability, the upper limit of the ten-point mean roughness Rzjis is preferably 4.5 μm or smaller, more preferably 4.3 μm or smaller, still more preferably 4.0 μm or smaller, and even still more preferably 3.9 μm or smaller. On the other hand, the lower limit of the ten-point mean roughness Rzjis is preferably 1.0 μm or greater, more preferably 1.2 μm or greater, and still more preferably 1.3 μm or greater from the viewpoint of increasing the adhesion with the resin.

Also, although no upper limit is imposed on the Density Of Peaks Spd, it is generally 100000/mm² or lower. From the viewpoint of increasing the adhesion between the base material and the roughened nickel-plating layer, the upper limit of the Density Of Peaks Spd is preferably 80000/mm² or lower, more preferably 70000/mm² or lower, and still more preferably 60000/mm² or lower. On the other hand, the lower limit of the Density Of Peaks Spd is preferably 20000/mm² or higher, more preferably 23000/mm² or higher, still more preferably 24000/mm² or higher, and even still more preferably 27000/mm² or higher from the viewpoint of increasing the adhesion with the resin.

Moreover, it is also preferred for the nickel-plated metal sheet of the present embodiment to specify, in a range that realizes shorter joining times, the arithmetical mean curvature Spc of peaks on the surface on the side of the roughened nickel layer 50. Specifically, if the arithmetical mean curvature Spc of the peaks is 200/mm or greater and smaller than 390/mm, it is preferred to satisfy a relation of Spd≥33.3 Spc+15000, or if Spc is 390/mm or greater, it is preferred to satisfy Spd≥28000. Satisfaction of these can be expected to obtain particularly high adhesion between the plating layer and another member.

If the Density Of Peaks Spd is 28000/mm² or higher, that is, relatively high, there are sufficiently many points of contact between the resin and the roughened portion, so that a particularly high adhesion strength can be obtained in a resin adhesion test to be mentioned later if Spc is 200/mm or greater. Further, if Spd is 20000/mm² or higher and lower than 28000/mm², higher anchoring effect can be obtained to achieve a particularly high adhesion strength if the relation of Spd≥33.3 Spc+15000 is satisfied and Spc is 200/mm or higher and lower than 390/mm, that is, protrusion tips are relatively rounded. If Spc is lower than 200/mm, on the other hand, the protrusions themselves are excessively rounded, so that sufficient anchoring effect is less likely to be manifested, and the resin adhesion is prone to decrease.

The arithmetical mean roughness Ra represents a mean value of roughness on the surface of the roughened portion in the nickel-plated metal sheet of the present embodiment.

From the viewpoint of increasing the resin flowability, the upper limit of the arithmetical mean roughness Ra is preferably 0.77 μm or smaller, more preferably 0.75 μm or smaller, and still more preferably 0.68 μm or smaller. On the other hand, the lower limit of the arithmetical mean roughness Ra is preferably 0.15 μm or greater, more preferably 0.17 μm or greater, and still more preferably 0.2 μm or greater from the viewpoint of increasing the adhesion with the resin.

A maximum height Sz represents a difference in height from a highest point on the surfaces of the protrusions on the roughened portion to a lowest point of the roots on the roughened portion in the nickel-plated metal sheet of the present embodiment.

From the viewpoint of increasing the resin flowability, the upper limit of the maximum height Sz is preferably 8.5 μm or smaller, more preferably 7.5 μm or smaller, and still more preferably 6.5 μm or smaller. On the other hand, the lower limit of the maximum height Sz is preferably 2.2 μm or greater, more preferably 2.3 μm or greater, and still more preferably 2.4 μm or greater from the viewpoint of increasing the adhesion with the resin.

An arithmetical mean height Sa represents the mean of the absolute values of the heights of individual points relative to the mean plane of the surface of the roughened portion in the nickel-plated metal sheet of the present embodiment.

From the viewpoint of increasing the resin flowability, the upper limit of the arithmetical mean height Sa is preferably 0.65 μm or smaller, more preferably 0.64 μm or smaller, and still more preferably 0.63 μm or smaller. On the other hand, the lower limit of the arithmetical mean height Sa is preferably 0.15 μm or greater, more preferably 0.17 μm or greater, and still more preferably 0.2 μm or greater from the viewpoint of increasing the adhesion with the resin.

It is to be noted that, by a known laser microscope or the like, the ten-point mean roughness Rzjis and the arithmetical mean roughness Ra can be measured in accordance with JIS B0601:2013, and the Density Of Peaks Spd, the arithmetical mean curvature Spc of the peaks, the maximum height Sz, and the arithmetical mean height Sa can be measured in accordance with International Organization for Standardization (ISO) 25178.

In the nickel-plated metal sheet 100 of the present embodiment, the deposition amount per side of nickel in the roughened nickel layer 50 is preferably 16 g/m² or less, more preferably 15 g/m² or less, and still more preferably 14 g/m² or less from the viewpoints of productivity and manufacturing cost. From the viewpoints of corrosion resistance and obtaining the intended roughened shape, on the other hand, the deposition amount per side of nickel in the roughened nickel layer 50 is preferably 2 g/m² or more, more preferably 3 g/m² or more, and still more preferably 4 g/m² or more. It is to be noted that the deposition amount of nickel in the roughened nickel layer 50 can be measured by X-ray fluorescence (XRF) analysis or the like.

As a measuring method of the nickel deposition amount in the present embodiment, the method described in PCT Patent Publication No. WO2020/017655 or PCT Patent Publication No. WO2021/020338, or the like can be appropriately adopted, for example. Specifically, the nickel deposition amount can be determined by measuring the total nickel amount with respect to the nickel-plated metal sheet 100 using X-ray fluorescence (XRF) analysis or the like.

A description will be made regarding the thickness of the whole nickel-plated metal sheet 100 in the present embodiment. Here, for the “thickness of the nickel-plated metal sheet 100” in the present embodiment, thickness measurement by cross-sectional observation under an SEM or thickness measurement by a micrometer can be also applied.

As the thickness of the whole nickel-plated metal sheet 100 in the present embodiment, a range of 0.02 to 1.01 mm is suited. If used as a current collector in a battery, for example, improvement in volumetric and gravimetric energy densities is required. Taking into consideration balancing of lightweighting and thinning with strength, the thickness of the whole nickel-plated metal sheet 100 is hence more preferably 0.02 to 0.51 mm, still more preferably 0.02 to 0.31 mm, and even still more preferably 0.026 to 0.11 mm. In applications as members or the like for electronic devices, electric appliances, automobiles, and constructions, for example, the thickness of the whole nickel-plated metal sheet 100 is preferably 0.026 to 1.01 mm, more preferably 0.11 to 1.01 mm, still more preferably 0.21 to 1.01 mm, and even still more preferably 0.51 to 1.01 mm from the viewpoints of rigidity, strength, and workability. For the thickness of the whole nickel-plated metal sheet 100, thickness measurement by a micrometer or cross-sectional observation under an optical microscope or a scanning electron microscope (SEM) is suitably used.

If used as a current collector in a battery, a case in which the thickness is greater than the upper limit of the above-described thickness range is not preferred from the viewpoints of the volumetric and gravimetric energy densities of the battery to be manufactured, especially if the aim is to thin the battery. With a thickness smaller than the lower limit of the above-described thickness range, on the other hand, it is not only difficult to have sufficient strength against effects associated with charging and discharging of the battery, but also highly possible to induce ripping, tearing, wrinkling, and/or the like during manufacture, handling, and the like of the battery. If used as members for electronic devices, electric appliances, automobiles, and constructions, a case in which the thickness is greater than the upper limit of the above-described thickness range is not preferred from the viewpoints of workability and lightweighting. On the other hand, a thickness smaller than the lower limit of the above-described thickness range is not preferred from the viewpoints of the rigidity and strength of the members so obtained.

According to the nickel-plated metal sheet 100 in the present embodiment, the resin flowability, as described above, can be further improved while having both adhesion of the plating layer with a base material and adhesion of the plating layer with another member. When the plating layer is joined with another member, it is hence possible to shorten the joining time or to lower the joining temperature compared to the conventional technology, so that reduction of environmental load and improvement of productivity can be expected.

### Modification of First Example

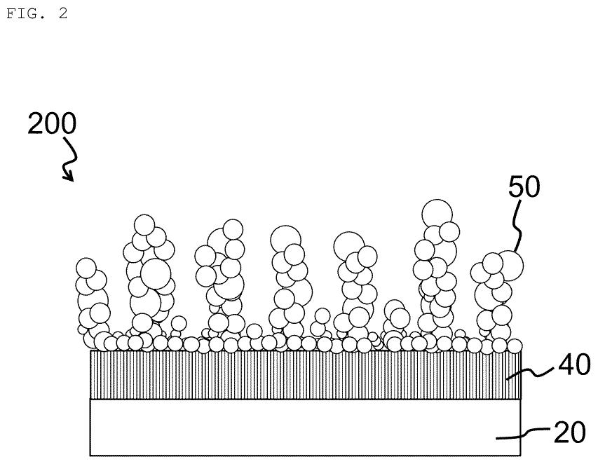

Using FIG. 2, a description will next be made regarding a nickel-plated metal sheet 200 as a modification of the above-mentioned first example. The nickel-plated metal sheet 200 in the present modification is different from the above-mentioned first embodiment in that the metal layer 40 is included between the roughened nickel layer 50 and the base material 20. Accordingly, this different point will be primarily described, the other points will be identified by the same reference signs, and their description is omitted. It is to be noted that, in the present modification, the ten-point mean roughness Rzjis and Density Of Peaks Spd on the outermost surface on the side of the roughened nickel layer are also 1.0 to 4.5 μm and 20000/mm² or greater, respectively.

### <Metal Layer 40>

The metal layer 40 is disposed between the base material 20 and the roughened nickel layer 50 as mentioned above. As a metallic material that forms the metal layer 40, nickel or a nickel alloy is mentioned, for example. It is to be noted that the metal layer 40 is presented as a single layer in FIG. 2, but, without being limited to this configuration, may be formed of a plurality of layers.

As an example of the metal layer 40, an iron-nickel alloy layer, a nickel-phosphorus alloy layer, or a nickel layer can be exemplified. If the metal layer 40 is an iron-nickel alloy layer, the alloy phase formed of iron and nickel may be any one of a solid solution, an eutectoid/eutectic, or a compound (intermetallic compound), or two or more of these phases may coexist. Further, the metal layer 40 may contain one or more metal elements other than iron and nickel, and inevitable impurities, and may also contain metal elements such as cobalt (Co) and molybdenum (Mo) and an additive element such as boron (B).

In the nickel-plated metal sheet 200, the preferred range of the nickel deposition amount per side in the roughened nickel layer 50 is the same as that in the nickel-plated metal sheet 100.

The total nickel deposition amount per side in the metal layer 40 and the roughened nickel layer 50 in the nickel-plated metal sheet 200 is, as an upper limit, preferably 40 g/m² or less, more preferably 35 g/m² or less, and still more preferably 32 g/m² or less from the viewpoints of productivity and manufacturing cost. In view of unavailability of corrosion resistance and the intended roughened shape, on the other hand, the lower limit is preferably 4 g/m² or more, more preferably 5 g/m² or more, and still more preferably 6 g/m².

As a measuring method of the nickel deposition amount in the nickel-plated metal sheet 200, the method described in PCT Patent Publication No. WO2020/017655 or PCT Patent Publication No. WO2021/020338, or the like can be appropriately adopted, for example. Specifically, the total nickel amount per side in the metal layer 40 and the roughened nickel layer 50 can be measured by using X-ray fluorescence (XRF) analysis or the like with respect to the nickel-plated metal sheet 200. As an alternative, the respective nickel amounts in the metal layer 40 and the roughened nickel layer 50 can be determined by ascertaining a boundary between the metal layer 40 and the roughened nickel layer 50 on a cross-sectional image or the like. It is to be noted that, if the base material 20 is a surface diffusion-treated steel sheet and the metal layer 40 is a nickel alloy layer, ascertainment of the boundary between the base material 20 and the metal layer 40 is difficult, and if this is the case, the total nickel amount per side in the base material 20, the metal layer 40, and the roughened nickel layer 50 may be controlled to the above-described range.

As effects of the formation of the metal layer 40 on the base material 20 in the nickel-plated metal sheet 200, the following points can be mentioned. Specifically, the formation of the metal layer 40 can ensure the adhesion of the roughened nickel layer 50 with the base material 20, and can improve the corrosion resistance of the whole nickel-plated metal sheet 200.

As the thickness of the whole nickel-plated metal sheet 200, a range of 0.02 to 1.01 mm is suited. If used as a current collector in a battery, for example, improvement in volumetric and gravimetric energy densities is required. Taking into consideration balancing of lightweighting and thinning with strength, the thickness of the whole nickel-plated metal sheet 200 is hence more preferably 0.02 to 0.51 mm, still more preferably 0.02 to 0.31 mm, and even still more preferably 0.026 to 0.11 mm. In applications as members or the like for electronic devices, electric appliances, automobiles, and constructions, for example, the thickness of the whole nickel-plated metal sheet 200 is preferably 0.026 to 1.01 mm, more preferably 0.11 to 1.01 mm, still more preferably 0.21 to 1.01 mm, and even still more preferably 0.51 to 1.01 mm from the viewpoints of rigidity, strength, and workability. For the thickness of the whole nickel-plated metal sheet 200, thickness measurement by a micrometer or cross-sectional observation under an optical microscope or a scanning electron microscope (SEM) is suitably used.

### Second Embodiment

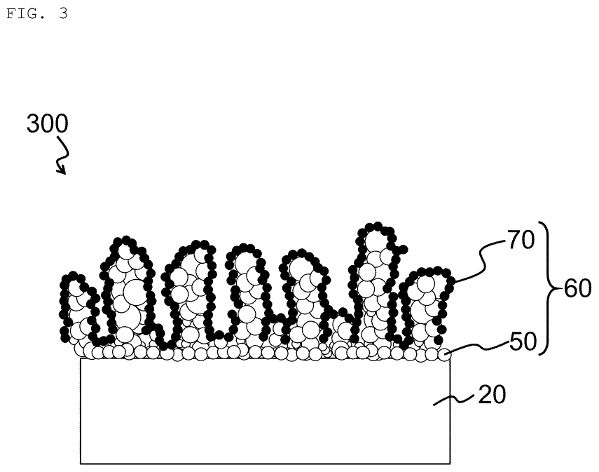

On the basis of FIG. 3, a nickel-plated metal sheet 300 in a second embodiment will next be described. The nickel-plated metal sheet 300 in the second embodiment is different from the above-mentioned first embodiment in that a coating layer 70 is included on the roughened nickel layer 50. Accordingly, this different point will be primarily described, the other points will be identified by the same reference signs, and their description is omitted. It is to be noted that, in the nickel-plated metal sheet 300, the roughened nickel layer 50 and the coating layer 70 will be collectively called a “composite roughened plating layer 60.” In the nickel-plated metal sheet 300, the ten-point mean roughness Rzjis and Density Of Peaks Spd on the outermost surface on the side of the composite roughened plating layer 60 are 1.0 to 4.5 μm and 20000/mm² or higher, respectively.

### <Coating Layer 70>

As mentioned above, the coating layer 70 is disposed on the roughened nickel layer 50. Examples of a metal material forming the coating layer 70 include zinc (Zn), tin (Sn), and chromium (Cr), and alloys thereof. It is to be noted that, if the metal material forming the coating layer 70 is chromium or an alloy thereof in the present disclosure, the coating layer 70 shall include a chromate film. The coating layer 70 contributes to improvement in adhesion between the roughened nickel layer 50 and the base material 20. Further, if the coating layer 70 contains zinc, this is advantageous in that sacrificial corrosion protection property is imparted to the whole nickel-plated metal sheet 300. Furthermore, if the coating layer 70 contains tin, this is advantageous because, if the nickel-plated metal sheet 300 is used, for example, as a current collector in a battery, the hydrogen overpotential can be set high, leading to a suppression of hydrogen generation. In addition, if the coating layer 70 contains chromium, the corrosion resistance of the entire nickel-plated metal sheet 300 can be further improved, and the adhesion between the resin and the roughened portion can be improved.

A preferred deposition amount in the coating layer 70 is as follows. If the coating layer 70 is zinc, the zinc deposition amount is, as an upper limit, preferably 22.0 g/m² or less, more preferably 17.0 g/m² or less, and still more preferably 15.0 g/m² or less from the viewpoints of productivity and manufacturing cost and obtaining the intended roughened shape. The lower limit of the zinc deposition amount is preferably 0.5 g/m² or more, more preferably 3.5 g/m² or more, and still more preferably 5.0 g/m² or more, from the viewpoints of corrosion resistance and increasing the adhesion between the base material and the roughened nickel-plating layer. If the coating layer 70 is tin, the tin deposition amount is, as an upper limit, preferably 22.0 g/m² or less, more preferably 17.0 g/m² or less, and still more preferably 15.0 g/m² or less from the viewpoints of productivity and manufacturing cost and obtaining the intended roughened shape. The lower limit of the tin deposition amount is preferably 0.5 g/m² or more, more preferably 3.5 g/m² or more, and still more preferably 5.0 g/m² or more, from the viewpoints of corrosion resistance and increasing the adhesion between the base material and the roughened nickel-plating layer. If the coating layer 70 is chromium, the chromium deposition amount is, as an upper limit, preferably 22.0 g/m² or less, more preferably 17.0 g/m² or less, and still more preferably 15.0 g/m² or less from the viewpoints of productivity and manufacturing cost and obtaining the intended roughened shape. The lower limit of the chromium deposition amount is preferably 0.1 g/m² or more, more preferably 0.3 g/m² or more, still more preferably 0.5 g/m² or more, and even still more preferably 0.8 g/m² or more, from the viewpoints of corrosion resistance and increasing the adhesion between the base material and the roughened nickel-plating layer. The measurement of a preferred deposition amount in the coating layer 70 can be conducted by using a known method such as X-ray fluorescence (XRF) analysis or inductively coupled plasma (ICP) emission spectroscopy.

The coating layer 70 in tis embodiment can be formed on the roughened nickel layer 50 by electroplating, sputtering, vapor deposition, chemical vapor deposition, or the like of the corresponding metal. Electroplating is particularly preferred from the viewpoints of manufacturing cost and capability of uniform coating to the roughened portion.

### Modification of Second Example

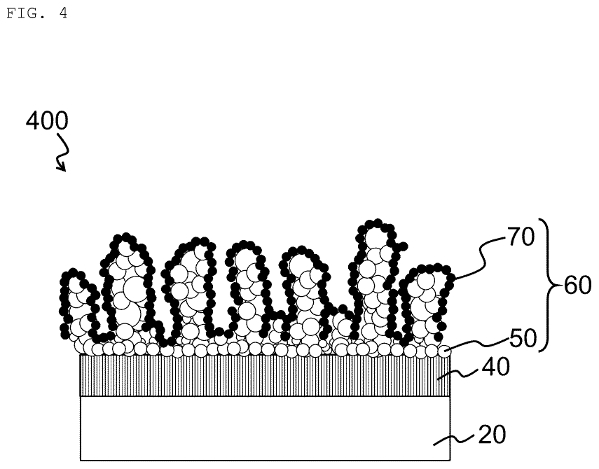

Using FIG. 4, a description will next be made regarding a nickel-plated metal sheet 400 as a modification of the above-mentioned second example. The nickel-plated metal sheet 400 in the present modification is different from the above-mentioned second embodiment in that a metal layer 40 is included between the composite roughened plating layer 60 and the base material 20. As the metal layer 40, the metal layer 40 described in the above-mentioned modification of the first example can be applied. Accordingly, the metal layer in the present modification is identified by the same reference sign, and its description is omitted. It is to be noted that, in the present modification, the ten-point mean roughness Rzjis and Density Of Peaks Spd on the outermost surface on the side of the roughened nickel layer are also 1.0 to 4.5 μm and 20000/mm² or greater, respectively.

### <<Manufacturing Process of Nickel-Plated Metal Sheet>>

A description will hereinafter be made regarding a manufacturing process of a nickel-plated metal sheet. The manufacturing process of the present embodiment for the nickel-plated metal sheet is characterized by including, in a roughened nickel plating step of forming the roughened nickel layer 50, a granular nickel-forming plating step of applying roughened nickel plating using a circulating bath at an average current density of 20.0 A/dm² or higher, a bath temperature of 50° C. or higher, and a rate that the solution circulation rate by a pump for a plating solution of, for example, 2 L volume exceeds a flow rate of 1 L/min. It is to be noted that the roughened nickel-plating step, which forms the roughened nickel layer 50, may include only the below-described “granular nickel-forming plating step,” or may include the below-described “granular nickel-forming plating step” and “nickel-growing plating step.”

As a plating bath in the granular nickel-forming plating step, the chloride ion concentration is preferably 3 to 90 g/L, more preferably 3 to 75 g/L, and still more preferably 3 to 50 g/L, the ratio of nickel ions to ammonium ions is preferably 0.05 to 0.75, more preferably 0.05 to 0.60, still more preferably 0.05 to 0.50, and even still more preferably 0.05 to 0.30 in terms of the weight ratio of “nickel ions/ammonium ions,” and the bath electrical conductivity at 50° C. is preferably 5.00 to 30.00 S/m, more preferably 5.00 to 20.00 S/m, and still more preferably 7.00 to 20.00 S/m. It is to be noted that, if the chloride ion concentration is 10 g/L or higher, a good roughened plating state is easily obtained even if the deposition amount in the roughened nickel-plating is somewhat small. Examples of a method that adjusts the chloride ion concentration, the ratio of nickel ions to ammonium ions, and the bath electrical conductivity in the plating bath to the above-described ranges include, but are not particularly limited to, a method that uses, as the plating bath, one containing nickel sulfate hexahydrate, nickel chloride hexahydrate, and ammonium sulfate, and appropriately adjusts their blending amounts.

Examples of plating conditions are as follows.

### [Granular Nickel-Forming Plating Conditions]

Bath composition
Nickel sulfate hexahydrate: 10 to 100 g/L, nickel chloride hexahydrate: 1 to 90 g/L, ammonium sulfate: 10 to 130 g/L
pH: 4.0 to 8.0
Bath temperature: 50° C. or higher
Average current density: 20 A/dm² or higher
Plating time: 5 to 150 seconds
Electricity quantity: 100 to 1500 C/dm²
Agitated/not agitated, etc.: circulating bath (a rate that the solution circulation rate by a pump for the plating solution of, for example, 2 L volume exceeds a flow rate of 1 L/min)
Under the above-described conditions, plating treatment can be conducted once or a plurality of times in the circulating bath such that the total electricity quantity is controlled as described above.

It is to be noted that the addition of ammonia to the nickel-plating bath may be conducted by using ammonia solution, ammonium chloride, or the like in place of ammonium sulfate. The ammonium ion concentration in the plating bath is preferably 6 to 35 g/L, more preferably 10 to 35 g/L, still more preferably 16 to 35 g/L, and even still more preferably 20 to 35 g/L. Further, hydrochloric acid, sodium chloride, potassium chloride, or the like may be used to control the chloride ion concentration.

As agitation conditions for the plating bath in the granular nickel-forming plating step, a circulating bath system that circulates the plating solution by a pump is desired. Specifically, it is preferred to continuously circulate, through the plating solution of 2 L volume, the plating solution at a rate higher than 1 L/min. A higher circulation rate of the plating solution is preferred if the bath temperature is high, a higher circulation rate of the plating solution is preferred if the average current density is high, and a higher circulation rate of the plating solution is preferred if the nickel ion concentration is low. Although no particular limitation is imposed on the upper limit of the circulation rate of the plating solution, 20 L/min or lower is preferred. To control the roughened portion to an intended shape, however, there is a need to conduct plating by controlling the bath temperature, the average current density, and the circulation rate of the plating solution under adequate conditions.

Further, by increasing the average current density and bath temperature to 20 A/dm² or higher and 50° C. or higher, respectively, in the above-described plating solution, formation of more plating nuclei can be promoted. As a result, the number of protrusions on the roughened portion can be increased, and hence, the Density Of Peaks Spd can be increased to 20000/mm² or higher. The upper limit of the average current density is preferably 50 A/dm² or lower from the viewpoint of increasing the adhesion between the base material and the roughed nickel-plating layer. Furthermore, growth of the plating nuclei so formed can be promoted by continuously conducting the circulation of the plating solution at a rate higher than 1 L/min. A roughened portion of an intended shape can be formed by conducting plating while controlling the bath temperature, the average current density, and the circulation rate of the plating solution under adequate conditions.

The upper limit of the nickel deposition amount in the granular nickel-forming plating step is preferably 16 g/m² or less, more preferably 15 g/m² or less, and still more preferably 14 g/m² or less from the viewpoints of resin flowability, productivity, and manufacturing cost. On the other hand, the lower limit is preferably 1.8 g/m² or more, more preferably 2.8 g/m² or more, and still more preferably 3.8 g/m² or more, from the viewpoint of resin adhesion.

### [Nickel-Growing Plating Conditions]

Bath composition:
Nickel sulfate hexahydrate 200 to 350 g/L, nickel chloride hexahydrate 20 to 60 g/L, boric acid 10 to 50 g/L
pH: 3.0 to 5.0
Bath temperature: 40° C. to 70° C.
Current density: 5 to 30 A/dm²

The upper limit of the nickel deposition amount in the nickel-growing plating step is preferably 7.0 g/m² or less, more preferably 6.0 g/m² or less, and still more preferably 5.0 g/m² or less from the viewpoints of the adhesion to another member, productivity, and manufacturing cost. On the other hand, the lower limit is preferably 0.2 g/m² or more, more preferably 0.4 g/m² or more, from the viewpoint of the adhesion of the plating layer with the base material. It is to be noted that the above-described nickel-growing plating step is not an essential step.

It is preferred that, by going through the above-described steps, the ten-point mean roughness Rzjis fall to 1.0 to 4.5 μm on the outermost surface on the side of the roughened nickel layer of the nickel-plated metal sheet so obtained and the Density Of Peaks Spd on the outermost surface on the side of the above-described roughened nickel layer fall to 20000/mm² or greater.

It is also preferred that, on the outermost surface on the side of the roughened nickel layer of the nickel-plated metal sheet so obtained, Spd≥33.3 Spc+15000 be satisfied if the arithmetical mean curvature Spc is 200/mm or greater and smaller than 390/mm or Spd 28000 be satisfied if Spc is 390/mm or greater.

The manufacturing process of the nickel-plated metal sheet depicted in FIG. 3 or 4 may further include a step of forming the coating layer 70 (coating-layer forming step). Specifically, the coating-layer forming step is conducted at least after the above-mentioned granular nickel-forming plating step. As an alternative, the coating-layer forming step may also be conducted by following the granular nickel-forming plating step and the nickel-growing plating step.

If the coating-layer forming step is conducted by zinc plating, examples of bath composition and plating conditions for the zinc plating are as follows.
Zinc sulfate heptahydrate: 100 to 400 g/L
Ammonium sulfate: 10 to 100 g/L
Bath temperature: 30° C. to 70° C.
pH: 1.0 to 5.0
Agitation: air agitation or jet agitation
Current density: 2.5 to 60 A/dm²

As described above, it is possible to use, as a plating bath for use in zinc plating, a bath that uses a sulfate salt as a supply source for zinc ions and is appropriately added with a conductive adjuvant salt such as ammonium sulfate or sulfuric acid to increase the electrical conductivity of the plating solution. In addition, an additive such as a known gloss agent may be added to the plating bath to form gloss zinc plating or semi-gloss zinc plating.

If the coating-layer forming step is conducted by tin plating, examples of bath composition and plating conditions for the tin plating are as follows.
Stannous sulfate: 30 to 80 g/L
Phenolsulfonic acid: 30 to 60 g/L
Ethoxylated α-naphthol: 2 to 6 g/L
Ethoxylated α-naphtholsulfonic acid: 4 to 12 g/L
pH: 0.1 to 2.0
Bath temperature: 20° C. to 55° C.
Agitation: air agitation or jet agitation
Current density: 2.5 to 10 A/dm²

If the coating-layer forming step is conducted by chromium plating, examples of bath composition and plating conditions for the chromium plating are as follows.
Chromium(VI) oxide: 30 to 200 g/L
Sodium fluoride: 1 to 10 g/L
pH: 1.0 or lower
Bath temperature: 35° C. to 65° C.
Agitation: air agitation or jet agitation
Current density: 5 to 50 A/dm²

If the coating-layer forming step is conducted by zinc plating, the zinc deposition amount to be formed by the zinc plating is preferably 0.5 to 22.0 g/m². The measurement of the zinc deposition amount can be conducted by using a known method such as X-ray fluorescence (XRF) analysis or ICP emission spectroscopy.

The manufacturing process of the nickel-plated metal sheet depicted in FIG. 2 or FIG. 4 may further include a step of forming the metal layer 40 (metal-layer forming step). Specifically, the metal-layer forming step is conducted on the base material 20 before the above-described granular nickel-forming plating step. As the metal layer 40 formed by the metal-layer forming step, an iron-nickel alloy layer, a nickel-phosphorus alloy layer, or a nickel layer is mentioned.

If the iron-nickel alloy layer is formed by the metal-layer forming step, it may be formed by applying alloy electrolytic plating to at least one side of the base material 20 using an alloy plating bath containing iron ions and nickel ions. In this case too, known alloy plating conditions can be appropriately applied.

If the nickel-phosphorus alloy layer is formed by the metal-layer forming step, a nickel-phosphorus alloy layer may be formed by applying alloy electrolytic plating to at least one side of the base material 20 using an alloy plating bath containing nickel ions and phosphorus ions.

If the nickel layer is formed by the metal-layer forming step, the nickel layer can be formed on at least one side of the base material 20, for example, in a known Watts bath or the like.

The metal-layer forming step is not needed to be a single step, and may be conducted by appropriately combining a plurality of steps. For example, the nickel-phosphorus alloy layer and the nickel layer may be both formed by the metal-layer forming step.

If a surface diffusion-treated steel sheet is used as the base material 20, an iron-nickel alloy layer can be formed through thermal diffusion by applying heat treatment after forming a nickel-plating layer by electrolytic plating.

Specifically, continuous annealing or batch annealing (box annealing) can be conducted. As examples of a temperature and time in a case of continuous annealing treatment, the continuous annealing treatment can be conducted at 650° C. to 950° C. for a soaking time in a range of 15 to 150 seconds. As examples of a temperature and time in a case of batch annealing (box annealing) treatment, the batch annealing (box annealing) treatment can be conducted at 450° C. to 690° C., for a soaking time in a range of 1.5 to 20 hours, and for a total time of heatup, soaking, and cooling time in a range of 4 to 80 hours. Rolling may be applied after the above-described heat treatment. Further, heat treatment may be conducted again after the rolling.

### EXAMPLES

The present invention will hereinafter be described more specifically by giving examples. A description will first be made regarding measuring methods in the examples.

### [Measuring Methods of Surface Texture Parameters]

Surface texture parameters on the surface of the roughened nickel layer 50, such as the ten-point mean roughness Rzjis, the arithmetical mean roughness Ra, the Density Of Peaks Spd, the arithmetical mean curvature Spc of peaks, the maximum height Sz, and the arithmetical mean height Sa were measured by using a laser microscope (manufactured by Olympus Corporation, 3D measuring laser microscope “LEXT OLS5000”). In the measurements of Rzjis and Ra, the surface of the roughened nickel layer 50 was measured with a 50× objective lens (lens name: “MPLAPON50XLEXT”) following JIS B0601:2013, whereby an analysis image of 257 μm×257 μm visual field was acquired. Using an analysis application, denoising and an inclination correction as automated correction processing were then conducted on the analysis image so acquired. Subsequently, the ten-point mean roughness Rzjis and the arithmetical mean roughness Ra were calculated by line roughness measurement. It is to be noted that the analysis was conducted under no conditions without setting any of filter criteria (tilt correction λf, low-pass filter λs, high-pass filter λc) at the time of the analysis. Mean values upon 15 measurements under the above-described conditions were calculated. In the measurements of the Density Of Peaks Spd, the arithmetical mean curvature Spc of peaks, the maximum height Sz, and the arithmetical mean height Sa, the surface of the roughened nickel layer 50 was measured with a 100× objective lens (lens name: “MPLAPON100X LEXT”) following ISO 25178, whereby an analysis image of 128 μm×128 μm visual field was acquired. As in the analysis of Rzjis and Ra, on the analysis image so acquired, denoising and an inclination correction were conducted, followed by analysis through surface roughness measurement with the filter criteria set to S filter: 2 μm, whereby the Density Of Peaks Spd, the arithmetical mean curvature Spc of peaks, the maximum height Sz, and the arithmetical mean height Sa were calculated. Mean values upon 3 measurements under the above-described conditions were calculated. It is to be noted that, for the analysis of Spd and Spc, the use of an S filler is essential to have the roughened shape recognized as particles. As an approximate estimate of a spot diameter is calculated to be 0.52 μm from the specification (numerical aperture 0.95) of the 100× objective lens (lens name: “MPLAPON100X LEXT”) and the wavelength (405 nm) of a laser beam, the setting of the S filter used 2 μm such that the setting value was sufficiently large compared with the spot diameter to assure the accuracy of measurement and also to make it possible to analyze fine roughness. In addition, a prescribed size to be determined as a peak was set to the 5% height of the maximum amplitude of surface waviness.

### [Measuring Method and Evaluation of Adhesion Between Base Material and Roughened Nickel Layer]

First, one with a self-adhesive tape (manufactured by of NICHIBAN Co., Ltd., tradename “CELLOTAPE” (registered trademark)) applied to a base paper sheet was provided as a reference sample. Using a spectrophotometer (manufactured by Konica Minolta, Inc., “CM-5”), its lightness L* and chromaticities a* and b* were measured. It is to be noted that, upon measurement, the CIE 1976 L*a*b* color difference model was used.

After a self-adhesive tape of the same kind as that used for the above-described reference sample was then applied to a surface, on which a roughened nickel layer was formed, as obtained in each example or comparative example so as to cover a range of 24 mm width and 50 mm length, a peel test by the self-adhesive tape so applied was conducted under the guidelines of the pull-off testing method described in JIS H 8504. The self-adhesive tape after the peel test was applied to a base paper sheet of the same kind as that of the above-described reference sample, and its lightness L* and chromaticities a* and b* were measured by using the spectrophotometer as above. From the measurement results of the lightness L* and chromaticities a* and b* of the reference sample as measured beforehand and the measurement results of the lightness L* and chromaticities a* and b* of the self-adhesive tape after the peel test, their difference ΔE*ab (ΔE*ab=[(ΔL*)²+(Δa*)²+(Δb*)²]^{1/2}) was calculated, and an evaluation of the adhesion of the roughened nickel layer was conducted on the basis of the following criteria. Here, it is possible to determine that the smaller the ΔE*ab, the amount peeled in the peel test is smaller, in other words, the residual ratio of the roughened nickel layer after the peel test is high, and the adhesion with the base material is excellent.

$$EXCELLENT : Δ E * ab = smaller than 1$$

$$GOOD : Δ E * ab = 1 or greater , smaller than 10$$

$$POOR : Δ E * ab = 10 or greater$$

### [Resin Adhesion Test (Peel Test) and Evaluation]

As an evaluation of the adhesion with another member, the adhesion with resin was evaluated. Specifically, for the evaluation of the resin adhesion, a peel test was conducted to obtain a peel strength. A description will hereinafter be made regarding its measuring method.

A nickel-plated metal sheet (30 mm×100 mm), which was obtained in each example or comparative example and had a roughened nickel layer formed on at least one side thereof, was provided. A polypropylene film of 140 μm thickness (25 mm×100 mm) was overlaid on the side of a surface to be evaluated (the side of the roughened nickel layer) with their one end portions trued up, and was heat-sealed in a range of 25 mm×25 mm at an overlayed portion thereof by a heat sealer (manufactured by TESTER SANGYO CO., LTD., “TP-701-B”), whereby a specimen was obtained. The heat-sealing temperature, in other words, the setting temperature of the heat sealer was set to 156° C., and the pressure at the time of the heat sealing was set to 0.1 MPa. Under two conditions that the time (hereinafter also referred to as “press time”), for which pressing was conducted at the above-described setting temperature under the above-described pressure, was 5 seconds and 6 seconds, specimens were prepared, respectively, by the heat sealer. By a tensile testing machine (manufactured by Orientec Co., Ltd., “RTC-121OA”), each specimen so prepared was fixed on a jig with the resin film folded back at the heat-sealed end as a starting point in 180° direction relative to the nickel-plated metal sheet, and was pulled at a rate of 50 mm/min, whereby its 180° peel strength was obtained. In the specimens of each example or comparative example, it was possible to confirm that there was no difference in 180° peel strength between one the press time of which at the time of the heat sealing was 5 seconds and the other one the press time of which at the time of the heat sealing was 6 seconds. It was therefore confirmed that, in each specimen, the 180° peel strength reached a maximum value in at least 5 seconds (the 180° peel strength does not become higher than the maximum value even if the time is made longer). Regarding the 180° peel strength that the 180° peel strength of each specimen, the press time of which at the time of the heat sealing was 5 seconds, is described as the maximum value (described “100% strength” in the table), an evaluation was hence conducted as will be described below.
EXCELLENT: the value of 90% (described “90% strength” in the table) relative to the maximum value of 180° peel strength was 12N/25 mm or higher
GOOD: the value of 90% relative to the maximum value of 180° peel strength was 9N/25 mm or higher and lower than 12N/25 mm
POOR: the value of 90% relative to the maximum value of 180° peel strength was lower than 9N/25 mm

### [Resin Flowability Evaluation Test and Evaluation Criteria]

Under the guidelines of the above-mentioned 180° peel strength test, the press time at the time of heat sealing was varied, and, for every press time, a specimen was prepared as in the peel strength test. As the variations of the press time, the preparation was carried out for 15 variations of 0.3 seconds, 0.5 seconds, 0.7 seconds, 1.0 seconds, 1.3 seconds, 1.5 seconds, 1.7 seconds, 2.0 seconds, 2.3 seconds, 2.5 seconds, 2.7 seconds, 3.0 seconds, 3.5 seconds, 4.0 seconds, and 4.5 seconds. The respective specimens of the different press time were pulled by the tensile testing machine as above, and their 180° peel strengths were obtained. By confirming the time required for the 180° peel strength of each specimen of different press time to reach a strength of 90% or higher relative to the maximum value, an evaluation was conducted as follows.
EXCELLENT: the time required to reach a strength of 90% or higher relative to the maximum value of 180° peel strength was shorter than 2 seconds
GOOD: the time required to reach a strength of 90% or higher relative to the maximum value of 180° peel strength was 2 seconds or longer and shorter than 3 seconds
MODERATE: the time required to reach a strength of 90% or higher relative to the maximum value of 180° peel strength was 3 seconds or longer and shorter than 4 seconds
POOR: the time required to reach a strength of 90% or higher relative to the maximum value of 180° peel strength was 4 seconds or longer

It is possible to determine, by this test and evaluation, that the shorter the time required to reach a strength of 90% or higher relative to the maximum value of 180° peel strength, the easier the shape is to flow to the roughened nickel surface. In a manufacturing step to have resin joined to a roughened nickel surface, for example, it is possible to obtain effects such as being easy to realize a joint strength as designed in addition to being advantageous from the viewpoints of time cut-down and energy efficiency.

### Example 1

A cold-rolled steel sheet (60 μm thickness) of low-carbon aluminum-killed steel having a chemical composition presented below was first provided.

C: 0.04 wt %, Mn: 0.32 wt %, Si: 0.01 wt %, P: 0.012 wt %, S: 0.014 wt %, Balance: Fe and inevitable impurities

After electrolytic degreasing and pickling by dipping in sulfuric acid were next carried out on the above-described cold-rolled steel sheet, a nickel layer was formed to a deposition amount of 8.9 g/m² by known nickel plating. Subsequently, thermal diffusion treatment was conducted by a continuous annealing step, and quality control rolling was applied, whereby an iron-nickel alloy layer of 2.2 μm thickness was formed on both sides. The resulting surface diffusion-treated steel sheet was provided as a base material 20.

On the surface diffusion-treated steel sheet as the base material 20, strike nickel-plating treatment was conducted under the strike nickel-plating conditions presented below, followed by formation of an undercoat nickel layer under undercoat nickel-plating conditions.

### <Strike Nickel-Plating Conditions>

Bath composition:
Nickel sulfate hexahydrate 250 g/L, sulfuric acid 50 g/L
pH: lower than 1.0
Bath temperature: 60° C.
Current density: 30 A/dm²
Electrolysis time: 5 seconds

### <Undercoat Nickel-Plating Conditions>

Bath composition:
Nickel sulfate hexahydrate 250 g/L, nickel chloride hexahydrate 45 g/L, boric acid: 30 g/L
pH: 4.0
Bath temperature: 60° C.
Current density: 10 A/dm²
Electrolysis time: 15.1 seconds

On the undercoat nickel layer on one side, a roughened nickel layer was next formed under the following conditions. It is to be noted that the roughened nickel layer was formed by applying the following granular nickel-forming plating and nickel-growing plating.

### <Granular Nickel-Forming Plating Conditions>

Concentration of nickel sulfate hexahydrate in plating bath: 10 g/L
Concentration of nickel chloride hexahydrate in plating bath: 10 g/L
Concentration of chloride ions in plating bath: 16.6 g/L
Ratio of nickel ions to ammonium ions in plating bath: nickel ions/ammonium ions (weight ratio)=0.2
pH: 6.0
Bath temperature: 50° C.
AVERAGE current density: 20.0 A/dm²
Electrolysis time: 15.4 seconds
Agitation method: circulation agitation (agitation flow rate: low)
Electrical conductivity of the plating bath (bath electrical conductivity): 13.8 S/m (with a proviso in the case of bath temperature 50° C. and pH=6.0)

It is to be noted that, in the examples and comparative examples, agitation flow rates in circulation agitation were described according to the following criteria.
High agitation flow rate: the solution circulation rate by a pump for the plating solution of 2 L volume was 3 L/min or higher and lower than 4 L/min
Medium agitation flow rate: the solution circulation rate by the pump for the plating solution of 2 L volume was 2 L/min or higher and lower than 3 L/min
Low agitation flow rate: the solution circulation rate by the pump for the plating solution of 2 L volume was 1 L/min or higher and lower than 2 L/min
No agitation: the solution circulation rate by the pump for the plating solution of 2 L volume was lower than 1 L/min

### <Nickel-Growing Plating Conditions>

Bath composition:
Nickel sulfate hexahydrate 250 g/L, nickel chloride hexahydrate 45 g/L, boric acid: 30 g/L
pH: 4.0
Bath temperature: 60° C.
Current density: 10 A/dm²
Electrolysis time: 1.3 seconds

Values of the ten-point mean roughness Rzjis, arithmetical mean roughness Ra, Density Of Peaks Spd, arithmetical mean curvature Spc of peaks, maximum height Sz, and arithmetical mean height Sa on the outermost surface of the above-described roughened nickel layer are presented in Table 1. It is to be noted that these surface texture parameters were measured by using the laser microscope (manufactured by Olympus Corporation, 3D measuring laser microscope “LEXT OLS5000”). In the measurements of Rzjis and Ra, the outermost surface of the roughened nickel layer was measured with the 50× objective lens, and the analysis was conducted under no conditions without setting any of filter criteria at the time of the analysis. In the measurements of Spd, Spc, Sz, and Sa, the outermost surface of the roughened nickel layer was measured with the 100× objective lens, the filter criteria upon analysis were set to S filter: 2 μm, and the analysis was conducted. An adhesion between the base material and the roughened nickel-plating layer, a 180° peel strength test, and a resin flowability test were also conducted.

It is to be noted that the nickel deposition amount in the roughened nickel layer was measured by using the X-ray fluorescence spectrometer (manufactured by Rigaku Corporation, “ZSX100e”), and the value so obtained is presented in Table 1. It is also to be noted that the specific measuring method is similar to the method described in PCT Patent Publication No.

WO2020/017655, and therefore, its detailed description is omitted herein.

### Example 2

As a base material 20, a steel sheet having no iron-nickel alloy layer was used. Specifically, one obtained by carrying out electrolytic degreasing and pickling by dipping in sulfuric acid on the cold-rolled steel sheet described in Example 1 was used as a base material 20. Otherwise, the procedures of Example 1 were followed. The results so obtained are presented in Table 1.

### Example 3

Conditions for undercoat nickel plating, granular nickel-forming plating, and nickel-growing plating were set as in Table 2. Otherwise, the procedures of Example 1 were followed. The results so obtained are presented in Table 1.

### Example 4

Conditions for undercoat nickel plating, granular nickel-forming plating, and nickel-growing plating were set as in Table 2. Otherwise, the procedures of Example 1 were followed. The results so obtained are presented in Table 1.

### Example 5

Conditions for undercoat nickel plating, granular nickel-forming plating, and nickel-growing plating were set as in Table 2. Otherwise, the procedures of Example 1 were followed. The results so obtained are presented in Table 1.

### Example 6

Conditions for undercoat nickel plating, granular nickel-forming plating, and nickel-growing plating were set as in Table 2. Otherwise, the procedures of Example 1 were followed. The results so obtained are presented in Table 1.

### Example 7

Conditions for undercoat nickel plating, granular nickel-forming plating, and nickel-growing plating were set as in Table 2. Otherwise, the procedures of Example 1 were followed. The results so obtained are presented in Table 1.

### Example 8

Conditions for undercoat nickel plating, granular nickel-forming plating, and nickel-growing plating were set as in Table 2. Otherwise, the procedures of Example 2 were followed. The results so obtained are presented in Table 1.

### Example 9

Conditions for undercoat nickel plating, granular nickel-forming plating, and nickel-growing plating were set as in Table 2. Otherwise, the procedures of Example 1 were followed. The results so obtained are presented in Table 1.

### Example 10

Conditions for undercoat nickel plating, granular nickel-forming plating, and nickel-growing plating were set as in Table 2. Otherwise, the procedures of Example 1 were followed. The results so obtained are presented in Table 1.

### Example 11

Conditions for undercoat nickel plating, granular nickel-forming plating, and nickel-growing plating were set as in Table 2. Otherwise, the procedures of Example 2 were followed. The results so obtained are presented in Table 1.

### Example 12

Conditions for undercoat nickel plating, granular nickel-forming plating, and nickel-growing plating were set as in Table 2. Otherwise, the procedures of Example 1 were followed. The results so obtained are presented in Table 1.

### Example 13

Conditions for undercoat nickel plating, granular nickel-forming plating, and nickel-growing plating were set as in Table 2. Otherwise, the procedures of Example 1 were followed. The results so obtained are presented in Table 1.

### Example 14

Conditions for undercoat nickel plating, granular nickel-forming plating, and nickel-growing plating were set as in Table 2. Otherwise, the procedures of Example 1 were followed. The results so obtained are presented in Table 1.

### Example 15

Conditions for undercoat nickel plating, granular nickel-forming plating, and nickel-growing plating were set as in Table 2. Otherwise, the procedures of Example 1 were followed. The results so obtained are presented in Table 1.

### Example 16

Conditions for undercoat nickel plating, granular nickel-forming plating, and nickel-growing plating were set as in Table 2. Otherwise, the procedures of Example 1 were followed. The results so obtained are presented in Table 1.

### Comparative Example 1

Conditions for undercoat nickel plating, granular nickel-forming plating, and nickel-growing plating were set as in Table 2. Otherwise, the procedures of Example 1 were followed. The results so obtained are presented in Table 1. It is to be noted that no resin flowability evaluation was possible due to occurrence of separation of the film shortly after joining.

### Comparative Example 2

Conditions for undercoat nickel plating, granular nickel-forming plating, and nickel-growing plating were set as in Table 2. Otherwise, the procedures of Example 1 were followed. The results so obtained are presented in Table 1. It is to be noted that no resin flowability evaluation was possible due to occurrence of separation of the film shortly after joining.

### Comparative Example 3

Conditions for undercoat nickel plating, granular nickel-forming plating, and nickel-growing plating were set as in Table 2. Otherwise, the procedures of Example 1 were followed. The results so obtained are presented in Table 1. It is to be noted that no resin flowability evaluation was possible due to occurrence of separation of the film shortly after joining.

### Comparative Example 4

Conditions for undercoat nickel plating, granular nickel-forming plating, and nickel-growing plating were set as in Table 2. Otherwise, the procedures of Example 2 were followed. The results so obtained are presented in Table 1. It is to be noted that no resin flowability evaluation was possible due to occurrence of separation of the film shortly after joining.

### Comparative Example 5

Conditions for undercoat nickel plating, granular nickel-forming plating, and nickel-growing plating were set as in Table 2. Otherwise, the procedures of Example 1 were followed. The results so obtained are presented in Table 1. It is to be noted that no resin flowability evaluation was possible due to occurrence of separation of the film shortly after joining.

### Comparative Example 6

Conditions for undercoat nickel plating, granular nickel-forming plating, and nickel-growing plating were set as in Table 2. Otherwise, the procedures of Example 1 were followed. The results so obtained are presented in Table 1.

### Comparative Example 7

Conditions for undercoat nickel plating, granular nickel-forming plating, and nickel-growing plating were set as in Table 2. Otherwise, the procedures of Example 1 were followed. The results so obtained are presented in Table 1.

### Comparative Example 8

Conditions for undercoat nickel plating, granular nickel-forming plating, and nickel-growing plating were set as in Table 2. Otherwise, the procedures of Example 1 were followed. The results so obtained are presented in Table 1.

### Comparative Example 9

Conditions for undercoat nickel plating, granular nickel-forming plating, and nickel-growing plating were set as in Table 2. Otherwise, the procedures of Example 1 were followed. The results so obtained are presented in Table 1.

### Comparative Example 10

Conditions for undercoat nickel plating, granular nickel-forming plating, and nickel-growing plating were set as in Table 2. Otherwise, the procedures of Example 1 were followed. The results so obtained are presented in Table 1.

### Comparative Example 11

Conditions for undercoat nickel plating, granular nickel-forming plating, and nickel-growing plating were set as in Table 2. Otherwise, the procedures of Example 2 were followed. The results so obtained are presented in Table 1.

### Comparative Example 12

Conditions for undercoat nickel plating, granular nickel-forming plating, and nickel-growing plating were set as in Table 2. Otherwise, the procedures of Example 1 were followed. The results so obtained are presented in Table 1.

### Comparative Example 13

Conditions for undercoat nickel plating, granular nickel-forming plating, and nickel-growing plating were set as in Table 2. Otherwise, the procedures of Example 1 were followed. The results so obtained are presented in Table 1.

### Comparative Example 14

Conditions for undercoat nickel plating, granular nickel-forming plating, and nickel-growing plating were set as in Table 2. Otherwise, the procedures of Example 1 were followed. The results so obtained are presented in Table 1.

### Comparative Example 15

Conditions for undercoat nickel plating, granular nickel-forming plating, and nickel-growing plating were set as in Table 2. Otherwise, the procedures of Example 1 were followed. The results so obtained are presented in Table 1.

### Comparative Example 16

Conditions for undercoat nickel plating, granular nickel-forming plating, and nickel-growing plating were set as in Table 2. Otherwise, the procedures of Example 1 were followed. The results so obtained are presented in Table 1.

### Comparative Example 17

Conditions for undercoat nickel plating, granular nickel-forming plating, and nickel-growing plating were set as in Table 2. Otherwise, the procedures of Example 1 were followed. The results so obtained are presented in Table 1.

### Example 17

As a base material 20, a similar metal base material to that in Example 2 was first provided, and electrolytic degreasing and pickling by dipping in sulfuric acid were carried out as in Example 2. Subsequently, an undercoat nickel layer to be located between the base material and a roughened nickel layer was formed under similar conditions to those in Example 1.

Under the following conditions, a composite roughened plating layer was next formed on the undercoat nickel layer on one side. It is to be noted that the composite roughened plating layer was formed by the following granular nickel-forming plating step of forming a roughened nickel layer and coating layer forming step of forming a coating layer. The coating treatment step was conducted by zinc plating.

### <Granular Nickel-Forming Plating Conditions>

Concentration of nickel sulfate hexahydrate in plating bath: 10 g/L
Concentration of nickel chloride hexahydrate in plating bath: 10 g/L
Concentration of chloride ions in plating bath: 16.6 g/L
Ratio of nickel ions to ammonium ions in plating bath: nickel ions/ammonium ions (weight ratio)=0.2
pH: 6.0
Bath temperature: 50° C.
Average current density: 35.0 A/dm²
Electrolysis time: 8.0 seconds
Agitation method: circulation agitation (agitation flow rate: low)
Electrical conductivity of the plating bath (bath electrical conductivity): 13.8 S/m (with a proviso in the case of bath temperature 50° C. and pH=6.0)

### <Coating Layer Forming Conditions>

Bath composition:
Zinc sulfate heptahydrate: 220 g/L, ammonium sulfate 30 g/L
pH: 2.0 (An adjustment with sulfuric acid was conducted.)
Bath temperature: 45° C.
Current density: 7.2 A/dm²
Electrolysis time: 35 seconds
Under the above conditions, a coating zinc layer was obtained.

Values of the ten-point mean roughness Rzjis, arithmetical mean roughness Ra, Density Of Peaks Spd, arithmetical mean curvature Spc of peaks, maximum height Sz, and arithmetical mean height Sa on the outermost surface on the side of the composite roughened plating layer of the nickel-plated metal sheet were measured as in Example 1, and are presented in Table 3. It is to be noted that these surface texture parameters were measured by using the laser microscope (manufactured by Olympus Corporation, 3D measuring laser microscope “LEXT OLS5000”). In the measurements of Rzjis and Ra, the outermost surface on the side of the composite roughened plating layer was measured with the 50× objective lens, and the analysis was conducted under no conditions without setting any of filter criteria at the time of the analysis. In the measurements of Spd, Spc, Sz, and Sa, the outermost surface on the side of the composite roughened plating layer was measured with the 100× objective lens, the filter criteria upon analysis were set to S filter: 2 μm, and the analysis was conducted. An adhesion between the base material and the roughened nickel-plating layer, a 180° peel strength test, and a resin flowability test were also conducted.

It is to be noted that, concerning the nickel deposition amount in the composite roughened plating layer, its measurement was conducted by using the X-ray fluorescence spectrometer (manufactured by Rigaku Corporation, “ZSX100e”). It is to be noted that the specific measuring method is similar to the method described in PCT Patent Publication No. WO2020/017655, and therefore, its detailed description is omitted herein. On the other hand, concerning the zinc deposition amount of the coating zinc layer, its measurement was conducted by using the X-ray fluorescence spectrometer. Their values so obtained are presented in Table 3.

### Example 18

Conditions for undercoat nickel plating, granular nickel-forming plating, and coating zinc plating were set as in Table 4. Otherwise, the procedures of Example 17 were followed. The results so obtained are presented in Table 3.

### Example 19

A stainless steel sheet (SUS430) of 50 μm thickness having a chemical composition presented below was provided as a base material 20.

C: 0.12 wt %, Cr: 16 to 18 wt %, Si: 0.75 wt %, Mn: 1.00 wt % or lower, P: 0.04 wt % or lower, S: 0.03 wt % or lower, Balance: inevitable impurities

On the base material, strike nickel-plating treatment was conducted under the strike nickel-plating conditions presented in Example 1, followed by undercoat nickel plating, granular nickel-forming plating, and nickel-growing plating under the conditions of Table 6. Otherwise, the procedures of Example 1 were followed. The results so obtained are presented in Table 5.

### Example 20

A 40 μm-thick, rolled aluminum sheet (hereinafter also called an “aluminum sheet”) of an aluminum alloy (A8079) having a chemical composition presented below was provided as a base material 20.

Si: 0.05 to 0.30 wt %, Fe: 0.7 to 1.3 wt %, Cu: 0.05 wt % or lower, Zn: 0.10 wt % or lower, Balance: inevitable impurities

With respect to the above-described aluminum sheet, substitution plating of zinc was next conducted on a surface of the aluminum sheet under zincate treatment conditions presented below. Subsequently, undercoat nickel plating, granular nickel-forming plating, and nickel-growing plating were conducted by setting their conditions as presented in Table 6. The results so obtained are presented in Table 5.

### <Zincate Treatment Conditions>

### <<Degreasing Conditions>>

Bath composition:
Sodium hydroxide 22.5 g/L, sodium carbonate 4.5 g/L
pH: 12 or higher
Bath temperature: 25° C.
Dipping time: 2 minutes

### <<Pickling Conditions>>

Bath composition:
Sulfuric acid 70 g/L
pH: 1.0 or lower
Bath temperature: 25° C.
Dipping time: 2 minutes

### <<Desmut Conditions>>

Bath composition:
60% nitric acid 250 mL/L, ferric chloride solution 4 mL/L
pH: 1.0 or lower
Bath temperature: 25° C.
Dipping time: 30 seconds
   <<First zincate conditions>>
Bath composition:
Sodium hydroxide 150 g/L, Rochelle salt 50 g/L, zinc oxide 25 g/L, ferrous chloride 1.5 g/L
pH: 12 to 14
Bath temperature: 25° C.
Dipping time: 50 seconds

### <<Dezincate Conditions>>

Bath composition:
60% nitric acid 250 mL/L, ferric chloride solution 4 mL/L
pH: 1.0 or lower
Bath temperature: 25° C.
Dipping time: 30 seconds

### <<Second Zincate Conditions>>

Bath composition:
Sodium hydroxide 150 g/L, Rochelle salt 50 g/L, zinc oxide 25 g/L, ferrous chloride 1.5 g/L
pH: 12 to 14
Bath temperature: 25° C.
Dipping time: 50 seconds

### Comparative Example 18

Conditions for undercoat nickel plating, granular nickel-forming plating, and coating zinc plating were set as in Table 4. Otherwise, the procedures of Example 17 were followed. The results so obtained are presented in Table 3.

### Comparative Example 19

Conditions for undercoat nickel plating, granular nickel-forming plating, and coating zinc plating were set as in Table 4. Otherwise, the procedures of Example 17 were followed. The results so obtained are presented in Table 3.

### Comparative Example 20

Conditions for undercoat nickel plating, granular nickel-forming plating, and nickel-growing plating were set as in Table 6. Otherwise, the procedures of Example 19 were followed. The results so obtained are presented in Table 5.

### Comparative Example 21

Conditions for undercoat nickel plating, granular nickel-forming plating, and nickel-growing plating were set as in Table 6. Otherwise, the procedures of Example 19 were followed. The results so obtained are presented in Table 5.

### Comparative Example 22

Conditions for undercoat nickel plating, granular nickel-forming plating, and nickel-growing plating were set as in Table 6. Otherwise, the procedures of Example 20 were followed. The results so obtained are presented in Table 5.

### Example 21

As a base material 20, a similar metal base material to that in Example 2 was first provided, and electrolytic degreasing and pickling by dipping in sulfuric acid were carried out as in Example 2. Subsequently, an undercoat nickel layer to be located between the base material and a roughened nickel layer was formed under similar conditions to those in Example 1.

Under the following conditions, a composite roughened plating layer was next formed on the undercoat nickel layer on one side. It is to be noted that the composite roughened plating layer was formed by the following granular nickel-forming plating step of forming a roughened nickel layer and coating layer forming step of forming a coating layer. The coating treatment step was conducted by tin plating.

### <Granular Nickel-Forming Plating Conditions>

Concentration of nickel sulfate hexahydrate in plating bath: 10 g/L
Concentration of nickel chloride hexahydrate in plating bath: 10 g/L
Concentration of chloride ions in plating bath: 16.6 g/L
Ratio of nickel ions to ammonium ions in plating bath: nickel ions/ammonium ions (weight ratio)=0.2
pH: 6.0
Bath temperature: 50° C.
Average current density: 20.0 A/dm²
Electrolysis time: 27.5 seconds
Agitation method: circulation agitation (agitation flow rate: medium)
Electrical conductivity of the plating bath (bath electrical conductivity): 13.8 S/m (with a proviso in the case of bath temperature 50° C. and pH=6.0)

### <Coating Layer Forming Conditions>

Stannous sulfate: 80 g/L
Phenolsulfonic acid: 60 g/L
Ethoxylated α-naphthol: 3 g/L
Ethoxylated α-naphtholsulfonic acid: 3 g/L
pH: 1.0 (An adjustment with sulfuric acid was conducted.)
Bath temperature: 40° C.
Current density: 5.0 A/dm²
Electrolysis time: 23.8 seconds
Under the above conditions, a coating tin layer was obtained.

Values of the ten-point mean roughness Rzjis, arithmetical mean roughness Ra, Density Of Peaks Spd, arithmetical mean curvature Spc of peaks, maximum height Sz, and arithmetical mean height Sa on the outermost surface on the side of the composite roughened plating layer of the nickel-plated metal sheet were measured as in Example 17, and are presented in Table 7. It is to be noted that these surface texture parameters were measured by using the laser microscope (manufactured by Olympus Corporation, 3D measuring laser microscope “LEXT OLS5000”). In the measurements of Rzjis and Ra, the outermost surface on the side of the composite roughened plating layer was measured with the 50× objective lens, and the analysis was conducted under no conditions without setting any of filter criteria at the time of the analysis. In the measurements of Spd, Spc, Sz, and Sa, the outermost surface on the side of the composite roughened plating layer was measured with the 100× objective lens, the filter criteria upon analysis were set to S filter: 2 μm, and the analysis was conducted. An adhesion between the base material and the roughened nickel-plating layer, a 180° peel strength test, and a resin flowability test were also conducted.

It is to be noted that, concerning the nickel deposition amount in the composite roughened plating layer, its measurement was conducted by using the X-ray fluorescence spectrometer (manufactured by Rigaku Corporation, “ZSX100e”). It is to be noted that the specific measuring method is similar to the method described in PCT Patent Publication No. WO2020/017655, and therefore, its detailed description is omitted herein. On the other hand, concerning the tin deposition amount of the coating tin layer, its measurement was conducted by using the X-ray fluorescence spectrometer. Their values so obtained are presented in Table 8.

### Comparative Example 23

Conditions for undercoat nickel plating, granular nickel-forming plating, and coating tin plating were set as in Table 8. Otherwise, the procedures of Example 21 were followed. The results so obtained are presented in Table 7.

TABLE 1

| | | | | | | | DEPOSITION | DEPOSITION |
|---|---|---|---|---|---|---|---|---|
| | | | | | | | AMOUNT OF | AMOUNT OF |
| | LINE | | SURFACE | | | | GRANULAR | ROUGHENED |
| | ROUGHNESS | | TEXTURE | | | | NICKEL- | NICKEL- |
| | PARAMETERS | | PARAMETERS | | | | FORMING | PLATING |
| | Rzjis | Ra | Spd | Spc | Sz | Sa | PLATING | LAYER* |
| | (μm) | (μm) | (1/mm²) | (1/mm) | (μm) | (μm) | (g/m²) | (g/m²) |
| [symbol] xample 1 | 1.4 | 0.23 | 27527 | 213 | 2.70 | 0.24 | 4.4 | 4.8 |
| [symbol] xample 2 | 1.5 | 0.24 | 26623 | 252 | 2.92 | 0.23 | 4.6 | 5.0 |
| [symbol] xample 3 | 1.8 | 0.26 | 33385 | 366 | 3.19 | 0.24 | 6.0 | 6.7 |
| [symbol] xample 4 | 2.0 | 0.30 | 37903 | 327 | 2.95 | 0.25 | 6.3 | 6.7 |
| [symbol] xample 5 | 2.3 | 0.40 | 49744 | 477 | 4.25 | 0.31 | 4.8 | 7.5 |
| [symbol] xample 6 | 2.3 | 0.30 | 51331 | 391 | 2.83 | 0.21 | 5.3 | 8.0 |
| [symbol] xample 7 | 2.7 | 0.51 | 28655 | 536 | 5.91 | 0.61 | 7.6 | 10.3 |
| [symbol] xample 8 | 2.7 | 0.52 | 29051 | 541 | 6.01 | 0.54 | 7.7 | 10.4 |
| [symbol] xample 9 | 3.1 | 0.41 | 38025 | 526 | 4.08 | 0.30 | 10.6 | 14.6 |
| [symbol] ample 10 | 3.6 | 0.55 | 30151 | 752 | 6.27 | 0.43 | 11.0 | 14.1 |
| [symbol] ample 11 | 3.7 | 0.59 | 29856 | 742 | 6.41 | 0.47 | 11.1 | 14.2 |
| [symbol] ample 12 | 1.6 | 0.27 | 23559 | 284 | 3.56 | 0.25 | 5.3 | 6.9 |
| [symbol] ample 13 | 2.2 | 0.37 | 26591 | 387 | 4.00 | 0.27 | 8.3 | 10.9 |
| [symbol] ample 14 | 4.0 | 0.70 | 27151 | 797 | 6.68 | 0.54 | 11.4 | 14.1 |
| [symbol] ample 15 | 4.0 | 0.70 | 32349 | 708 | 6.63 | 0.56 | 11.5 | 15.4 |
| [symbol] ample 16 | 4.3 | 0.71 | 33020 | 1007 | 7.88 | 0.61 | 11.6 | 15.2 |
| Comparative | 0.9 | 0.18 | 6531 | 128 | 2.05 | 0.20 | 4.1 | 6.8 |
| Example 1 | | | | | | | | |
| Comparative | 1.0 | 0.26 | 9338 | 155 | 2.31 | 0.22 | 3.7 | 30.4 |
| Example 2 | | | | | | | | |
| Comparative | 1.2 | 0.24 | 12756 | 182 | 2.69 | 0.21 | 4.1 | 21.9 |
| Example 3 | | | | | | | | |
| Comparative | 1.3 | 0.25 | 12562 | 196 | 2.83 | 0.25 | 3.9 | 21.8 |
| Example 4 | | | | | | | | |
| Comparative | 1.8 | 0.40 | 9949 | 227 | 3.50 | 0.34 | 4.9 | 16.8 |
| Example 5 | | | | | | | | |
| Comparative | 2.6 | 0.43 | 18066 | 515 | 6.17 | 0.44 | 11.2 | 29.0 |
| Example 6 | | | | | | | | |
| Comparative | 2.9 | 0.59 | 18920 | 521 | 6.25 | 0.51 | 8.3 | 16.7 |
| Example 7 | | | | | | | | |
| Comparative | 3.2 | 0.58 | 14038 | 528 | 7.43 | 0.53 | 9.0 | 22.3 |
| Example 8 | | | | | | | | |
| Comparative | 4.8 | 0.78 | 25757 | 813 | 8.60 | 0.66 | 12.8 | 18.1 |
| Example 9 | | | | | | | | |
| Comparative | 5.1 | 0.91 | 20508 | 827 | 8.77 | 0.80 | 13.8 | 19.1 |
| Example 10 | | | | | | | | |
| Comparative | 5.1 | 0.92 | 21121 | 854 | 8.65 | 0.78 | 13.5 | 18.9 |
| Example 11 | | | | | | | | |
| Comparative | 5.5 | 0.91 | 22461 | 872 | 8.70 | 0.75 | 13.6 | 17.6 |
| Example 12 | | | | | | | | |
| Comparative | 6.4 | 1.05 | 12939 | 1259 | 16.67 | 1.12 | 6.3 | 17.0 |
| Example 13 | | | | | | | | |
| Comparative | 6.9 | 1.27 | 17883 | 1014 | 11.25 | 0.96 | 7.9 | 21.8 |
| Example 14 | | | | | | | | |
| Comparative | 4.9 | 0.79 | 14526 | 853 | 11.60 | 0.66 | 16.0 | 24.5 |
| Example 15 | | | | | | | | |
| Comparative | 4.7 | 0.85 | 25513 | 923 | 9.42 | 0.74 | 8.5 | 9.4 |
| Example 16 | | | | | | | | |
| Comparative | 5.0 | 0.86 | 25269 | 922 | 8.70 | 0.77 | 6.0 | 6.9 |
| Example 17 | | | | | | | | |

| | | | | | EVALUATION |
|---|---|---|---|---|---|
| | 180° PEEL STRENGTH (N/25 mm) | | | EVALUATION | OF PLATING |
| | 100% | 90% | | OF RESIN | LAYER |
| | STRENGTH | STRENGTH | EVALUATION | FLOWABILITY | ADHESION |
| [symbol] xample 1 | 15.4 | 13.9 | EXCELLENT | EXCELLENT | EXCELLENT |
| [symbol] xample 2 | 15.9 | 14.3 | EXCELLENT | EXCELLENT | EXCELLENT |
| [symbol] xample 3 | 15.0 | 13.5 | EXCELLENT | EXCELLENT | EXCELLENT |
| [symbol] xample 4 | 17.5 | 15.8 | EXCELLENT | EXCELLENT | EXCELLENT |
| [symbol] xample 5 | 28.7 | 25.8 | EXCELLENT | EXCELLENT | EXCELLENT |
| [symbol] xample 6 | 24.8 | 22.3 | EXCELLENT | EXCELLENT | EXCELLENT |
| [symbol] xample 7 | 14.3 | 12.9 | EXCELLENT | EXCELLENT | EXCELLENT |
| [symbol] xample 8 | 15.1 | 13.6 | EXCELLENT | EXCELLENT | EXCELLENT |
| [symbol] xample 9 | 13.5 | 12.2 | EXCELLENT | EXCELLENT | EXCELLENT |
| [symbol] ample 10 | 25.8 | 23.2 | EXCELLENT | EXCELLENT | EXCELLENT |
| [symbol] ample 11 | 26.2 | 23.6 | EXCELLENT | EXCELLENT | EXCELLENT |
| [symbol] ample 12 | 12.2 | 11.0 | GOOD | EXCELLENT | EXCELLENT |
| [symbol] ample 13 | 10.1 | 9.0 | GOOD | EXCELLENT | EXCELLENT |
| [symbol] ample 14 | 27.9 | 25.1 | EXCELLENT | GOOD | EXCELLENT |
| [symbol] ample 15 | 31.1 | 28.0 | EXCELLENT | GOOD | EXCELLENT |
| [symbol] ample 16 | 49.1 | 44.2 | EXCELLENT | GOOD | EXCELLENT |
| Comparative | 0.0 | 0.0 | POOR | | EXCELLENT |
| Example 1 | | | | | |
| Comparative | 0.0 | 0.0 | POOR | | EXCELLENT |
| Example 2 | | | | | |
| Comparative | 0.0 | 0.0 | POOR | | EXCELLENT |
| Example 3 | | | | | |
| Comparative | 0.0 | 0.0 | POOR | | EXCELLENT |
| Example 4 | | | | | |
| Comparative | 0.0 | 0.0 | POOR | | EXCELLENT |
| Example 5 | | | | | |
| Comparative | 5.5 | 4.9 | POOR | EXCELLENT | EXCELLENT |
| Example 6 | | | | | |
| Comparative | 3.3 | 3.0 | POOR | EXCELLENT | EXCELLENT |
| Example 7 | | | | | |
| Comparative | 1.8 | 1.6 | POOR | EXCELLENT | EXCELLENT |
| Example 8 | | | | | |
| Comparative | 34.1 | 30.7 | EXCELLENT | POOR | EXCELLENT |
| Example 9 | | | | | |
| Comparative | 36.4 | 32.8 | EXCELLENT | POOR | EXCELLENT |
| Example 10 | | | | | |
| Comparative | 40.2 | 36.2 | EXCELLENT | POOR | EXCELLENT |
| Example 11 | | | | | |
| Comparative | 54.1 | 48.6 | EXCELLENT | POOR | EXCELLENT |
| Example 12 | | | | | |
| Comparative | 33.2 | 29.8 | EXCELLENT | POOR | EXCELLENT |
| Example 13 | | | | | |
| Comparative | 33.5 | 30.1 | EXCELLENT | POOR | EXCELLENT |
| Example 14 | | | | | |
| Comparative | 12.3 | 11.1 | GOOD | POOR | EXCELLENT |
| Example 15 | | | | | |
| Comparative | 72.7 | 65.4 | EXCELLENT | POOR | POOR |
| Example 16 | | | | | |
| Comparative | 68.2 | 61.4 | EXCELLENT | POOR | POOR |
| Example 17 | | | | | |

*TOTAL VALUE OF DEPOSITION AMOUNT OF GRANULAR NICKEL-FORMING PLATING + DEPOSITION AMOUNT OF NICKEL-GROWING PLATING [symbol]
indicates data missing or illegible when filed

TABLE 2

| | | UNDERCOAT NICKEL-PLATING CONDITIONS | | | | | |
|---|---|---|---|---|---|---|---|
| | | | | | | | NICKEL |
| | | | | CURRENT | ELECTROLYSIS | | DEPOSITION |
| | BASE | | TEMPERATURE | DENSITY | TIME | BATH | AMOUNT |
| | MATERIAL | pH | (° C.) | (A/dm²) | (sec.) | CONDITIONS | (g/m²) |
| Example 1 | SURFACE | 4.0 | 60 | 10 | 15.1 | WATTS BATH | 4.5 |
| | DIFFUSION- | | | | | | |
| | TREATED | | | | | | |
| | STEEL SHEET | | | | | | |
| Example 2 | STEEL SHEET | 4.0 | 60 | 10 | 15.1 | WATTS BATH | 4.5 |
| Example 3 | SURFACE | 4.0 | 60 | 10 | 10.5 | WATTS BATH | 3.0 |
| | DIFFUSION- | | | | | | |
| | TREATED | | | | | | |
| | STEEL SHEET | | | | | | |
| Example 4 | SURFACE | 4.0 | 60 | 10 | 10.5 | WATTS BATH | 3.0 |
| | DIFFUSION- | | | | | | |
| | TREATED | | | | | | |
| | STEEL SHEET | | | | | | |
| Example 5 | SURFACE | 4.0 | 60 | 10 | 15.1 | WATTS BATH | 4.5 |
| | DIFFUSION- | | | | | | |
| | TREATED | | | | | | |
| | STEEL SHEET | | | | | | |
| Example 6 | SURFACE | 4.0 | 60 | 10 | 10.5 | WATTS BATH | 3.0 |
| | DIFFUSION- | | | | | | |
| | TREATED | | | | | | |
| | STEEL SHEET | | | | | | |
| Example 7 | SURFACE | 4.0 | 60 | 10 | 15.1 | WATTS BATH | 4.5 |
| | DIFFUSION- | | | | | | |
| | TREATED | | | | | | |
| | STEEL SHEET | | | | | | |
| Example 8 | STEEL SHEET | 4.0 | 60 | 10 | 15.1 | WATTS BATH | 4.5 |
| Example 9 | SURFACE | 4.0 | 60 | 10 | 10.5 | WATTS BATH | 3.0 |
| | DIFFUSION- | | | | | | |
| | TREATED | | | | | | |
| | STEEL SHEET | | | | | | |
| Example 10 | SURFACE | 4.0 | 60 | 10 | 10.5 | WATTS BATH | 3.0 |
| | DIFFUSION- | | | | | | |
| | TREATED | | | | | | |
| | STEEL SHEET | | | | | | |
| Example 11 | STEEL SHEET | 4.0 | 60 | 10 | 10.5 | WATTS BATH | 3.0 |
| Example 12 | SURFACE | 4.0 | 60 | 10 | 15.1 | WATTS BATH | 4.5 |
| | DIFFUSION- | | | | | | |
| | TREATED | | | | | | |
| | STEEL SHEET | | | | | | |
| Example 13 | SURFACE | 4.0 | 60 | 10 | 15.1 | WATTS BATH | 4.5 |
| | DIFFUSION- | | | | | | |
| | TREATED | | | | | | |
| | STEEL SHEET | | | | | | |
| Example 14 | SURFACE | 4.0 | 60 | 10 | 15.1 | WATTS BATH | 4.5 |
| | DIFFUSION- | | | | | | |
| | TREATED | | | | | | |
| | STEEL SHEET | | | | | | |
| Example 15 | SURFACE | 4.0 | 60 | 10 | 10.5 | WATTS BATH | 3.0 |
| | DIFFUSION- | | | | | | |
| | TREATED | | | | | | |
| | STEEL SHEET | | | | | | |
| Example 16 | SURFACE | 4.0 | 60 | 10 | 15.1 | WATTS BATH | 4.5 |
| | DIFFUSION- | | | | | | |
| | TREATED | | | | | | |
| | STEEL SHEET | | | | | | |
| Comparative | SURFACE | 4.0 | 60 | 10 | 10.5 | WATTS BATH | 3.0 |
| Example 1 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 2 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 3 | DIFFUSION- | | | | | | |
| | TREATED | | | | | | |
| | STEEL SHEET | | | | | | |
| Comparative | STEEL SHEET | 4.0 | 60 | 10 | 15.1 | WATTS BATH | 4.5 |
| Example 4 | | | | | | | |
| Comparative | SURFACE | 4.0 | 60 | 10 | 15.1 | WATTS BATH | 4.5 |
| Example 5 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 6 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 7 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 8 | DIFFUSION- | | | | | | |
| | TREATED | | | | | | |
| | STEEL SHEET | | | | | | |
| Comparative | SURFACE | 4.0 | 60 | 10 | 10.5 | WATTS BATH | 3.0 |
| Example 9 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 10 | DIFFUSION- | | | | | | |
| | TREATED | | | | | | |
| | STEEL SHEET | | | | | | |
| Comparative | STEEL SHEET | 4.0 | 60 | 10 | 15.1 | WATTS BATH | 4.5 |
| Example 11 | | | | | | | |
| Comparative | SURFACE | 4.0 | 60 | 10 | 10.5 | WATTS BATH | 3.0 |
| Example 12 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 13 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 14 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 15 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 16 | DIFFUSION- | | | | | | |
| | TREATED | | | | | | |
| | STEEL SHEET | | | | | | |
| Comparative | SURFACE | 4.0 | 60 | 10 | 15.1 | WATTS BATH | 4.5 |
| Example 17 | DIFFUSION- | | | | | | |
| | TREATED | | | | | | |
| | STEEL SHEET | | | | | | |

| | GRANULAR NICKEL-FORMING PLATING CONDITIONS | | | | | | |
|---|---|---|---|---|---|---|---|
| | | | | | NICKEL | AGITATION | |
| | | | CURRENT | ELECTROLYSIS | DEPOSITION | | FLOW |
| | | TEMPERATURE | DENSITY | TIME | AMOUNT | AGITATION | RATE |
| | pH | (° C.) | (A/dm²) | (sec.) | (g/m²) | METHOD | (L/min.) |
| Example 1 | 6.0 | 50 | 20.0 | 15.4 | 4.4 | CIRCULATED | LOW |
| Example 2 | 6.0 | 50 | 20.0 | 15.4 | 4.6 | CIRCULATED | LOW |
| Example 3 | 6.0 | 50 | 23.3 | 19.0 | 6.0 | CIRCULATED | MEDIUM |
| Example 4 | 6.0 | 57 | 23.3 | 20.0 | 6.3 | CIRCULATED | MEDIUM |
| Example 5 | 6.0 | 50 | 35.0 | 13.3 | 4.8 | CIRCULATED | HIGH |
| Example 6 | 6.0 | 60 | 27.0 | 17.3 | 5.3 | CIRCULATED | HIGH |
| Example 7 | 6.0 | 50 | 21.0 | 25.1 | 7.6 | CIRCULATED | MEDIUM |
| Example 8 | 6.0 | 50 | 21.0 | 25.1 | 7.7 | CIRCULATED | MEDIUM |
| Example 9 | 6.0 | 56 | 23.3 | 34.0 | 10.6 | CIRCULATED | MEDIUM |
| Example 10 | 6.0 | 54 | 20.0 | 37.8 | 11.0 | CIRCULATED | MEDIUM |
| Example 11 | 6.0 | 54 | 20.0 | 37.8 | 11.1 | CIRCULATED | MEDIUM |
| Example 12 | 6.0 | 50 | 20.0 | 18.8 | 5.3 | CIRCULATED | LOW |
| Example 13 | 6.0 | 50 | 21.5 | 26.9 | 8.3 | CIRCULATED | MEDIUM |
| Example 14 | 6.0 | 55 | 20.0 | 39.5 | 11.4 | CIRCULATED | MEDIUM |
| Example 15 | 6.0 | 50 | 22.0 | 36.6 | 11.5 | CIRCULATED | MEDIUM |
| Example 16 | 6.0 | 50 | 23.3 | 35.0 | 11.6 | CIRCULATED | MEDIUM |
| Comparative | 6.0 | 45 | 3.0 | 82.9 | 4.1 | NOT | <1 |
| Example 1 | | | | | | AGITATED | |
| Comparative | 6.0 | 40 | 5.0 | 45.0 | 3.7 | NOT | <1 |
| Example 2 | | | | | | AGITATED | |
| Comparative | 6.0 | 45 | 10.0 | 25.9 | 4.1 | NOT | <1 |
| Example 3 | | | | | | AGITATED | |
| Comparative | 6.0 | 45 | 10.0 | 25.9 | 3.9 | NOT | <1 |
| Example 4 | | | | | | AGITATED | |
| Comparative | 6.0 | 42 | 5.0 | 60.0 | 4.9 | NOT | <1 |
| Example 5 | | | | | | AGITATED | |
| Comparative | 6.0 | 35 | 13.0 | 35.8 | 11.2 | CIRCULATED | HIGH |
| Example 6 | | | | | | | |
| Comparative | 6.0 | 50 | 16.0 | 35.7 | 8.3 | NOT | <1 |
| Example 7 | | | | | | AGITATED | |
| Comparative | 6.0 | 45 | 12.0 | 48.6 | 9.0 | NOT | <1 |
| Example 8 | | | | | | AGITATED | |
| Comparative | 6.0 | 45 | 20.0 | 51.2 | 12.8 | CIRCULATED | LOW |
| Example 9 | | | | | | | |
| Comparative | 6.0 | 50 | 15.0 | 62.0 | 13.8 | CIRCULATED | LOW |
| Example 10 | | | | | | | |
| Comparative | 6.0 | 50 | 15.0 | 62.0 | 13.5 | CIRCULATED | LOW |
| Example 11 | | | | | | | |
| Comparative | 6.0 | 50 | 17.4 | 61.3 | 13.6 | CIRCULATED | LOW |
| Example 12 | | | | | | | |
| Comparative | 6.0 | 50 | 13.0 | 48.0 | 6.3 | NOT | <1 |
| Example 13 | | | | | | AGITATED | |
| Comparative | 6.0 | 50 | 20.0 | 35.0 | 7.9 | NOT | <1 |
| Example 14 | | | | | | AGITATED | |
| Comparative | 6.0 | 45 | 12.0 | 85.8 | 16.0 | NOT | <1 |
| Example 15 | | | | | | AGITATED | |
| Comparative | 6.0 | 35 | 20.0 | 35.0 | 8.5 | CIRCULATED | HIGH |
| Example 16 | | | | | | | |
| Comparative | 6.0 | 35 | 20.0 | 35.0 | 6.0 | NOT | <1 |
| Example 17 | | | | | | AGITATED | |

| | NICKEL-GROWING PLATING CONDITIONS | | | | |
|---|---|---|---|---|---|
| | | | | | NICKEL |
| | | | CURRENT | ELECTROLYSIS | DEPOSITION |
| | | TEMPERATURE | DENSITY | TIME | AMOUNT |
| | pH | (° C.) | (A/dm²) | (sec.) | (g/m²) |
| Example 1 | 4.0 | 60 | 10 | 1.3 | 0.4 |
| Example 2 | 4.0 | 60 | 10 | 1.3 | 0.4 |
| Example 3 | 4.0 | 60 | 10 | 2.4 | 0.7 |
| Example 4 | 4.0 | 60 | 10 | 1.3 | 0.4 |
| Example 5 | 4.0 | 60 | 10 | 9.5 | 2.7 |
| Example 6 | 4.0 | 60 | 10 | 9.0 | 2.7 |
| Example 7 | 4.0 | 60 | 10 | 9.5 | 2.7 |
| Example 8 | 4.0 | 60 | 10 | 9.5 | 2.7 |
| Example 9 | 4.0 | 60 | 10 | 13.5 | 4.0 |
| Example 10 | 4.0 | 60 | 10 | 10.5 | 3.1 |
| Example 11 | 4.0 | 60 | 10 | 10.5 | 3.1 |
| Example 12 | 4.0 | 60 | 2.7 | 20.0 | 1.6 |
| Example 13 | 4.0 | 60 | 10 | 9.5 | 2.7 |
| Example 14 | 4.0 | 60 | 10 | 9.5 | 2.7 |
| Example 15 | 4.0 | 60 | 10 | 13.5 | 4.0 |
| Example 16 | 4.0 | 60 | 10 | 12.8 | 3.6 |
| Comparative | 4.0 | 60 | 10 | 9.0 | 2.7 |
| Example 1 | | | | | |
| Comparative | 4.0 | 60 | 10 | 90.0 | 26.7 |
| Example 2 | | | | | |
| Comparative | 4.0 | 60 | 10 | 60.0 | 17.8 |
| Example 3 | | | | | |
| Comparative | 4.0 | 60 | 10 | 60.0 | 17.9 |
| Example 4 | | | | | |
| Comparative | 4.0 | 60 | 10 | 40.0 | 11.9 |
| Example 5 | | | | | |
| Comparative | 4.0 | 60 | 10 | 57.1 | 17.8 |
| Example 6 | | | | | |
| Comparative | 4.0 | 60 | 10 | 28.5 | 8.5 |
| Example 7 | | | | | |
| Comparative | 4.0 | 60 | 10 | 45.0 | 13.4 |
| Example 8 | | | | | |
| Comparative | 4.0 | 60 | 10 | 18.0 | 5.3 |
| Example 9 | | | | | |
| Comparative | 4.0 | 60 | 10 | 17.9 | 5.3 |
| Example 10 | | | | | |
| Comparative | 4.0 | 60 | 10 | 17.9 | 5.4 |
| Example 11 | | | | | |
| Comparative | 4.0 | 60 | 10 | 13.5 | 4.0 |
| Example 12 | | | | | |
| Comparative | 4.0 | 60 | 10 | 34.7 | 10.7 |
| Example 13 | | | | | |
| Comparative | 4.0 | 60 | 10 | 45.0 | 14.0 |
| Example 14 | | | | | |
| Comparative | 4.0 | 60 | 10 | 28.5 | 8.5 |
| Example 15 | | | | | |
| Comparative | 4.0 | 60 | 10 | 3.9 | 0.9 |
| Example 16 | | | | | |
| Comparative | 4.0 | 60 | 10 | 3.9 | 0.9 |
| Example 17 | | | | | |

TABLE 3

| | | | | | | | DEPOSITION | |
|---|---|---|---|---|---|---|---|---|
| | LINE | | SURFACE | | | | AMOUNT OF | 180° PEEL |
| | ROUGHNESS | | TEXTURE | | | | ROUGHENED | STRENGTH |
| | PARAMETERS | | PARAMETERS | | | | NICKEL- | (N/25 mm) |
| | Rzjis | Ra | Spd | Spc | Sz | Sa | PLATING | 100% |
| | (μm) | (μm) | (1/mm²) | (1/mm) | (μm) | (μm) | LAYER (g/m²) | STRENGTH |
| 7 | 3.5 | 0.60 | 22156 | 638 | 5.69 | 0.50 | 2.9 | 27.5 |
| 8 | 3.2 | 0.56 | 20447 | 544 | 5.55 | 0.46 | 3.4 | 14.9 |
| Comparative | 1.6 | 0.29 | 15442 | 225 | 2.90 | 0.21 | 3.6 | 8.5 |
| Example 18 | | | | | | | | |
| Comparative | 5.3 | 1.08 | 25489 | 802 | 8.61 | 1.02 | 3.9 | 15.4 |
| Example 19 | | | | | | | | |

| | | | | EVALUATION |
|---|---|---|---|---|
| | 180° PEEL STRENGTH (N/25 mm) | | EVALUATION | OF PLATING |
| | 90% | | OF RESIN | LAYER |
| | STRENGTH | EVALUATION | FLOWABILITY | ADHESION |
| 7 | 24.8 | EXCELLENT | EXCELLENT | EXCELLENT |
| 8 | 13.4 | EXCELLENT | EXCELLENT | EXCELLENT |
| Comparative | 7.6 | POOR | EXCELLENT | GOOD |
| Example 18 | | | | |
| Comparative | 13.8 | EXCELLENT | POOR | POOR |
| Example 19 | | | | |

TABLE 4

| | | UNDERCOAT NICKEL-PLATING CONDITIONS | | | | | |
|---|---|---|---|---|---|---|---|
| | | | | | | | NICKEL |
| | | | | CURRENT | ELECTROLYSIS | | DEPOSITION |
| | BASE | | TEMPERATURE | DENSITY | TIME | BATH | AMOUNT |
| | MATERIAL | pH | (° C.) | (A/dm²) | (sec.) | CONDITIONS | (g/m²) |
| Example 17 | STEEL | 4.0 | 60 | 10 | 15.1 | WATTS BATH | 4.5 |
| | SHEET | | | | | | |
| Example 18 | STEEL | 4.0 | 60 | 10 | 15.1 | WATTS BATH | 4.5 |
| | SHEET | | | | | | |
| Comparative | STEEL | 4.0 | 60 | 10 | 15.1 | WATTS BATH | 4.5 |
| Example 18 | SHEET | | | | | | |
| Comparative | STEEL | 4.0 | 60 | 10 | 15.1 | WATTS BATH | 4.5 |
| Example 19 | SHEET | | | | | | |

| | GRANULAR NICKEL-FORMING PLATING CONDITIONS | | | | | | |
|---|---|---|---|---|---|---|---|
| | | | | | NICKEL | AGITATION | |
| | | | CURRENT | ELECTROLYSIS | DEPOSITION | | FLOW |
| | | TEMPERATURE | DENSITY | TIME | AMOUNT | AGITATION | RATE |
| | pH | (° C.) | (A/dm²) | (sec.) | (g/m²) | METHOD | (L/min.) |
| Example 17 | 6.0 | 50 | 35.0 | 8.0 | 2.9 | CIRCULATED | LOW |
| Example 18 | 6.0 | 50 | 35.0 | 9.4 | 3.4 | CIRCULATED | LOW |
| Comparative | 6.0 | 45 | 10.0 | 22.0 | 3.6 | NOT | <1 |
| Example 18 | | | | | | AGITATED | |
| Comparative | 6.0 | 45 | 23.0 | 20.0 | 3.9 | NOT | <1 |
| Example 19 | | | | | | AGITATED | |

| | COATING LAYER FORMING CONDITIONS | | | | | |
|---|---|---|---|---|---|---|
| | | | | | | ZINC |
| | | | CURRENT | ELECTROLYSIS | | DEPOSITION |
| | | TEMPERATURE | DENSITY | TIME | BATH | AMOUNT |
| | pH | (° C.) | (A/dm²) | (sec.) | CONDITIONS | (g/m²) |
| Example 17 | 2.0 | 45 | 7.2 | 35.0 | ZINC | 7.2 |
| | | | | | PLATING | |
| | | | | | BATH | |
| Example 18 | 2.0 | 45 | 8.4 | 54.0 | ZINC | 13.6 |
| | | | | | PLATING | |
| | | | | | BATH | |
| Comparative | 2.0 | 45 | 7.2 | 30.0 | ZINC | 6.1 |
| Example 18 | | | | | PLATING | |
| | | | | | BATH | |
| Comparative | 2.0 | 45 | 8.4 | 48.0 | ZINC | 12.1 |
| Example 19 | | | | | PLATING | |
| | | | | | BATH | |

TABLE 5

| | | | | | | | DEPOSITION | DEPOSITION |
|---|---|---|---|---|---|---|---|---|
| | | | | | | | AMOUNT OF | AMOUNT OF |
| | LINE | | SURFACE | | | | GRANULAR | ROUGHENED |
| | ROUGHNESS | | TEXTURE | | | | NICKEL- | NICKEL- |
| | PARAMETERS | | PARAMETERS | | | | FORMING | PLATING |
| | Rzjis | Ra | Spd | Spc | Sz | Sa | PLATING | LAYER* |
| | (μm) | (μm) | (1/mm²) | (1/mm) | (μm) | (μm) | (g/m²) | (g/m²) |
| Example 19 | 2.5 | 0.39 | 87219 | 412 | 3.37 | 0.28 | 5.4 | 8.9 |
| Example 20 | 3.2 | 0.56 | 41870 | 596 | 7.20 | 0.61 | 5.1 | 5.4 |
| Comparative | 0.6 | 0.11 | 40405 | 68 | 0.88 | 0.09 | 1.2 | 1.8 |
| Example 20 | | | | | | | | |
| Comparative | 7.9 | 1.49 | 31860 | 837 | 11.28 | 1.16 | 9.6 | 20.2 |
| Example 21 | | | | | | | | |
| Comparative | 5.8 | 1.13 | 33020 | 886 | 9.42 | 1.18 | 5.5 | 8.7 |
| Example 22 | | | | | | | | |

| | | | | | EVALUATION |
|---|---|---|---|---|---|
| | 180° PEEL STRENGTH (N/25 mm) | | | EVALUATION | OF PLATING |
| | 100% | 90% | | OF RESIN | LAYER |
| | STRENGTH | STRENGTH | EVALUATION | FLOWABILITY | ADHESION |
| Example 19 | 35.2 | 31.7 | EXCELLENT | EXCELLENT | EXCELLENT |
| Example 20 | 17.4 | 15.7 | EXCELLENT | EXCELLENT | EXCELLENT |
| Comparative | 0.0 | 0.0 | POOR | | EXCELLENT |
| Example 20 | | | | | |
| Comparative | 43.9 | 39.5 | EXCELLENT | POOR | EXCELLENT |
| Example 21 | | | | | |
| Comparative | 21.1 | 19.0 | EXCELLENT | POOR | EXCELLENT |
| Example 22 | | | | | |

*TOTAL VALUE OF DEPOSITION AMOUNT OF GRANULAR NICKEL-FORMING PLATING + DEPOSITION AMOUNT OF NICKEL-GROWING PLATING

TABLE 6

| | | UNDERCOAT NICKEL-PLATING CONDITIONS | | | | | |
|---|---|---|---|---|---|---|---|
| | | | | | | | NICKEL |
| | | | | CURRENT | ELECTROLYSIS | | DEPOSITION |
| | BASE | | TEMPERATURE | DENSITY | TIME | BATH | AMOUNT |
| | MATERIAL | pH | (° C.) | (A/dm²) | (sec.) | CONDITIONS | (g/m²) |
| Example 19 | STAINLESS | 4.0 | 60 | 10 | 15.1 | WATTS BATH | 4.5 |
| | STEEL SHEET | | | | | | |
| Example 20 | ALUMINUM | 4.0 | 60 | 10 | 15.1 | WATTS BATH | 4.5 |
| | SHEET | | | | | | |
| Comparative | STAINLESS | 4.0 | 60 | 10 | 15.1 | WATTS BATH | 4.5 |
| Example 20 | STEEL SHEET | | | | | | |
| Comparative | STAINLESS | 4.0 | 60 | 10 | 15.1 | WATTS BATH | 4.5 |
| Example 21 | STEEL SHEET | | | | | | |
| Comparative | ALUMINUM | 4.0 | 60 | 10 | 15.1 | WATTS BATH | 4.5 |
| Example 22 | SHEET | | | | | | |

| | GRANULAR NICKEL-FORMING PLATING CONDITIONS | | | | | | |
|---|---|---|---|---|---|---|---|
| | | | | | NICKEL | AGITATION | |
| | | | CURRENT | ELECTROLYSIS | DEPOSITION | | FLOW |
| | | TEMPERATURE | DENSITY | TIME | AMOUNT | AGITATION | RATE |
| | pH | (° C.) | (A/dm²) | (sec.) | (g/m²) | METHOD | (L/min.) |
| Example 19 | 6.0 | 57 | 35.0 | 13.8 | 5.4 | CIRCULATED | MEDIUM |
| Example 20 | 6.0 | 60 | 25.0 | 13.0 | 5.1 | CIRCULATED | HIGH |
| Comparative | 6.0 | 35 | 23.0 | 4.0 | 1.2 | NOT | <1 |
| Example 20 | | | | | | AGITATED | |
| Comparative | 6.0 | 50 | 22.0 | 67.0 | 9.6 | NOT | <1 |
| Example 21 | | | | | | AGITATED | |
| Comparative | 6.0 | 50 | 22.0 | 37.0 | 5.5 | NOT | <1 |
| Example 22 | | | | | | AGITATED | |

| | NICKEL-GROWING PLATING CONDITIONS | | | | |
|---|---|---|---|---|---|
| | | | | | NICKEL |
| | | | CURRENT | ELECTROLYSIS | DEPOSITION |
| | | TEMPERATURE | DENSITY | TIME | AMOUNT |
| | pH | (° C.) | (A/dm²) | (sec.) | (g/m²) |
| Example 19 | 4.0 | 60 | 10 | 11.0 | 3.5 |
| Example 20 | 4.0 | 60 | 10 | 2.0 | 0.3 |
| Comparative | 4.0 | 60 | 10 | 5.0 | 1.4 |
| Example 20 | | | | | |
| Comparative | 4.0 | 60 | 10 | 32.0 | 10.6 |
| Example 21 | | | | | |
| Comparative | 4.0 | 60 | 10 | 11.0 | 3.2 |
| Example 22 | | | | | |

TABLE 7

| | | | | | | | DEPOSITION | |
|---|---|---|---|---|---|---|---|---|
| | LINE | | SURFACE | | | | AMOUNT OF | 180° PEEL |
| | ROUGHNESS | | TEXTURE | | | | ROUGHENED | STRENGTH |
| | PARAMETERS | | PARAMETERS | | | | NICKEL- | (N/25 mm) |
| | Rzjis | Ra | Spd | Spc | Sz | Sa | PLATING | 100% |
| | (μm) | (μm) | (1/mm²) | (1/mm) | (μm) | (μm) | LAYER (g/m²) | STRENGTH |
| [symbol] ple 21 | 3.7 | 0.61 | 50659 | 589 | 6.80 | 0.55 | 4.6 | 24.3 |
| Comparative | 5.5 | 0.93 | 33996 | 700 | 10.77 | 0.81 | 4.5 | 20.6 |
| Example 23 | | | | | | | | |

| | | | | EVALUATION |
|---|---|---|---|---|
| | 180° PEEL STRENGTH (N/25 mm) | | EVALUATION | OF PLATING |
| | 90% | | OF RESIN | LAYER |
| | STRENGTH | EVALUATION | FLOWABILITY | ADHESION |
| [symbol] ple 21 | 21.9 | EXCELLENT | EXCELLENT | EXCELLENT |
| Comparative | 18.5 | EXCELLENT | POOR | EXCELLENT |
| Example 23 | | | | |

[symbol]

indicates data missing or illegible when filed

TABLE 8

| | | UNDERCOAT NICKEL-PLATING CONDITIONS | | | | | |
|---|---|---|---|---|---|---|---|
| | | | | | | | NICKEL |
| | | | | CURRENT | ELECTROLYSIS | | DEPOSITION |
| | BASE | | TEMPERATURE | DENSITY | TIME | BATH | AMOUNT |
| | MATERIAL | pH | (° C.) | (A/dm²) | (sec.) | CONDITIONS | (g/m²) |
| [symbol] ple 21 | STEEL SHEET | 4.0 | 60 | 10 | 15.1 | WATTS BATH | 4.5 |
| Comparative | STEEL SHEET | 4.0 | 60 | 10 | 15.1 | WATTS BATH | 4.5 |
| Example 23 | | | | | | | |

| | GRANULAR NICKEL-FORMING PLATING CONDITIONS | | | | | | |
|---|---|---|---|---|---|---|---|
| | | | | | NICKEL | AGITATION | |
| | | | CURRENT | ELECTROLYSIS | DEPOSITION | | FLOW |
| | | TEMPERATURE | DENSITY | TIME | AMOUNT | AGITATION | RATE |
| | pH | (° C.) | (A/dm²) | (sec.) | (g/m²) | METHOD | (L/min.) |
| [symbol] ple 21 | 6.0 | 50 | 20.0 | 27.5 | 4.6 | CIRCULATED | MEDIUM |
| Comparative | 6.0 | 50 | 20.0 | 37.5 | 4.5 | NOT | <1 |
| Example 23 | | | | | | AGITATED | |

| | COATING LAYER FORMING CONDITIONS | | | | | |
|---|---|---|---|---|---|---|
| | | | | | | TIN |
| | | | CURRENT | ELECTROLYSIS | | DEPOSITION |
| | | TEMPERATURE | DENSITY | TIME | BATH | AMOUNT |
| | pH | (° C.) | (A/dm²) | (sec.) | CONDITIOS | (g/m²) |
| [symbol] ple 21 | 1.0 | 40 | 5.0 | 23.8 | TIN | 4.8 |
| | | | | | PLATING | |
| | | | | | BATH | |
| Comparative | 1.0 | 40 | 5.0 | 47.6 | TIN | 7.3 |
| Example 23 | | | | | PLATING | |
| | | | | | BATH | |

[symbol]

indicates data missing or illegible when filed

Examples 1 to 16 have been confirmed to have preferred characteristics in all of resin flowability, plating adhesion, and adhesion strength. In Comparative Examples 1 to 8, on the other hand, Spd was lower than 20000/mm², thereby failing to achieve the object in the viewpoint of adhesion strength. In Comparative Examples 9 to 17, Rzjis was greater than 4.5 μm, thereby failing to achieve the object in the viewpoint of resin flowability.

In more detail, comparing Example 7 and Comparative Example 6, for example, Rzjis was 2.7 μm, that is, smaller than 4.5 μm, in Example 7, so that the resin was able to easily flow to the roughened portion, and Example 7 was preferred in resin flowability. In addition, Spd was 28655/mm², that is, higher than 20000/mm², so that an anchoring effect for the resin was high, and a preferred adhesion strength was obtained. In Comparative Example 6, on the other hand, Rzjis was 2.6 μm and was comparable with that of Example 1, but the intended adhesion strength was not obtained because Spd was lower than 20000/mm².

Comparing Example 2 and Comparative Example 9, Spd was 26623/mm², that is, higher than 20000/mm², in Example 2, so that a preferred adhesion strength was obtained. Further, Rzjis was 1.5 μm, that is, smaller than 4.5 μm, so that Example 2 was confirmed to have preferred resin flowability. In Comparative Example 9, on the other hand, Spd was 26623/mm² and was comparable with that of Example 2, but the intended resin flowability was not obtained because Rzjis was 4.8 μm, that is, greater than 4.5 μm.

Comparing Example 6, Example 7, and Comparative Example 16, they were all comparable in the deposition amount of the roughened nickel layer, but Example 6 and Example 7, in which Rzjis and Spd satisfied the prescribed values, were confirmed to have preferred characteristics in all of resin flowability, plating adhesion, and adhesion strength. In Comparative Example 16, on the other hand, Rzjis was greater than 4.5 μm, so that resin flowability was not obtained. In addition, Comparative Example 16 and Comparative Example 17 were also insufficient in plating adhesion. This is considered to be attributable to the bath temperature of 35° C. at the time of granular nickel-forming plating and also to the significantly small nickel deposition amount at the time of nickel-growing plating.

From these results, it has been found that, to obtain preferred characteristics in all of resin flowability, plating adhesion, and adhesion strength, they cannot be obtained if Rzjis and the deposition amount are merely decreased and the control of Spd is important.

Example 17, Example 18, Comparative Example 18, and Comparative Example 19 are embodiments in which zinc was formed as a coating layer. In Example 17 and Example 18, Rzjis and Spd were smaller than 4.5 μm and 20000/mm² or higher, respectively, on the surface of the composite roughened plating layer with the coating layer made of zinc and formed thereon, and Example 17 and Example 18 have been confirmed to have preferred characteristics in all of resin flowability, plating adhesion, and adhesion strength. In Comparative Example 18, on the other hand, Spd was 15442/mm², that is, lower than 20000/mm², thereby failing to achieve the object in the viewpoint of adhesion strength. Further, in Comparative Example 19, Rzjis was 5.3 μm, that is, greater than 4.5 μm, so that the intended resin flowability was not obtained. In addition, Rzjis was 5.3 μm, that is, greater than 4.5 μm, and, as a result, the intended resin flowability was not obtained.

Example 19, Comparative Example 20, and Comparative Example 21 are embodiments in which a stainless steel sheet was used as a base material. On the other hand, Example 20 and Comparative Example 22 are embodiments in which an aluminum sheet was used as a base material. In Example 19 and Example 20, Rzjis was smaller than 4.5 μm, and Spd was 20000/mm² or higher, so that Example 19 and Example 20 have been confirmed to have preferred characteristics in all of resin flowability, plating adhesion, and adhesion strength. In Comparative Example 20, on the other hand, Rzjis was smaller 1.0 μm, resulting in a significant reduction in the adhesion with the resin. Further, in Comparative Example 21 and Comparative Example 22, Rzjis was greater than 4.5 μm, thereby failing to achieve the object in the viewpoint of resin flowability.

Example 21 and Comparative Example 23 are embodiments in which tin was formed as a coating layer. In Example 21, Rzjis and Spd were 4.5 μm or smaller and 20000/mm² or higher, respectively, on the surface of the composite roughened plating layer with the coating layer made of tin and formed thereon, and Example 21 has been confirmed to have preferred characteristics in all of resin flowability, plating adhesion, and adhesion strength. In Comparative Example 23, on the other hand, Rzjis was 5.5 μm, that is, greater than 4.5 μm, so that the intended resin flowability was not obtained.

Various modifications can be made to the above-described embodiments and the individual examples within a scope not departing from the spirit of the present disclosure.

### INDUSTRIAL APPLICABILITY

As described above, the nickel-plated metal sheet of the present disclosure can be used for various applications such as current collectors of positive electrodes and/or negative electrodes of secondary batteries and the like, members for electronic devices, electric appliances, automobiles, and constructions, and so on.

### REFERENCE SIGNS LIST

100, 200, 300, 400: Nickel-plated metal sheet
20: Base material
40: Metal layer
50: Roughened nickel layer
60: Composite roughened plating layer
70: Coating layer

1. A nickel-plated metal sheet comprising:
a base material made of metal; and
a roughened nickel layer formed on at least one side on the base material, wherein
a ten-point mean roughness Rzjis on an outermost surface on a side of the roughened nickel layer of the nickel-plated metal sheet is 1.0 to 4.5 μm, and
a Density Of Peaks Spd on the outermost surface on the side of the roughened nickel layer is 20000/mm² or higher.

2. The nickel-plated metal sheet according to claim 1, wherein the ten-point mean roughness Rzjis is 1.0 to 3.9 μm.

3. The nickel-plated metal sheet according to claim 2, wherein, if an arithmetical mean curvature Spc of peaks is 200/mm or greater and smaller than 390/mm, a relation of Spd≥33.3 Spc+15000 is satisfied, or if Spc is 390/mm or greater, Spd≥28000 is satisfied.

4. The nickel-plated metal sheet according to claim 1, wherein nickel exists in the outermost surface on the side of the roughened nickel layer.

5. The nickel-plated metal sheet according to claim 1, further comprising:
a zinc layer or a tin layer on the outermost surface on the side of the roughened nickel layer.

6. The nickel-plated metal sheet according to claim 1, wherein a deposition amount of nickel in the roughened nickel layer is 2.0 g/m² or more and 16 g/m² or less.

7. The nickel-plated metal sheet according to claim 1, wherein a thickness of the base material is 0.01 to 1.0 mm.

8. The nickel-plated metal sheet according to claim 1, wherein
the base material is any one of
a metal sheet or metal foil made of one type of pure metal selected from iron, copper, aluminum, and nickel,
a metal sheet or metal foil made of an alloy containing one type selected from iron, copper, aluminum, or nickel,
a nickel-plated steel sheet or a metal sheet applied on a surface thereof with an alloy phase of iron and nickel by subjecting a nickel-plated steel sheet to heat treatment, or
a zinc-plated steel sheet.

9. The nickel-plated metal sheet according to claim 1, wherein
a metal layer is included between the base material and the roughened nickel layer and
the metal layer is any one of an iron-nickel alloy layer, a nickel-phosphorus alloy layer, or a nickel layer.

10. The nickel-plated metal sheet according to claim 9, wherein a total nickel deposition amount per side in the metal layer and the roughened nickel layer, the side being on the side of the roughened nickel layer, of the nickel-plated metal sheet is 4 g/m² or more and 40 g/m² or less.
